(19) United States
(12) Patent Application Publication
(10) Pub. No.: US 2025/0247327 A1
(43) Pub. Date: Jul. 31, 2025

(54) Software-Defined Wide Area Networking (SD-WAN) Customer Equipment (CE) Node Traffic Steering within a Segment Routing (SR) over Internet Protocol Version 6 (SRV6) Network

(71) Applicant: Fortinet, Inc., Sunnyvale, CA (US)

(72) Inventors: Tuan A. NGUYEN, Sydney (AU); Krutartha PATEL, Sydney (AU)

(73) Assignee: Fortinet, Inc., Sunnyvale, CA (US)

(21) Appl. No.: 18/429,372

(22) Filed: Jan. 31, 2024

(51) Int. Cl. H04L 45/00; H04L 12/46; H04L 45/74; H04L 45/76

(52) U.S. Cl. CPC H04L 45/34; H04L 12/4633; H04L 45/74; H04L 45/76

(57) ABSTRACT

Systems and methods for facilitating traffic steering via an SRv6 network by SD-WAN CE nodes without requiring the SD-WAN CE nodes to have SRv6 routing capabilities is provided. According to one embodiment, an end-to-end SRv6 tunnel is established through the SRv6 network between a source SD-WAN CE node associated with a first LAN and a destination SD-WAN CE node associated with a second LAN. LAN-side traffic originated by the first LAN and destined for the second LAN is received by the source SD-WAN CE node. Based on the LAN-side traffic, the source SD-WAN CE node, may encapsulate the LAN-side traffic as payload of an IPv6 packet, including incorporating path information within an IPv6 SRH to instruct PE/P nodes of the SRv6 network how to steer the IPv6 packet through the SRv6 network. Forwarding the encapsulated LAN-side traffic by the SD-WAN CE node through the SRv6 network via the SRv6 tunnel.

### BACKGROUND

### Field

Various embodiments of the present disclosure generally relate to Software-Defined Wide Area Networking (SD-WAN) and Segment Routing (SR) over Internet Protocol version 6 (SRv6) Networks. In particular, some embodiments relate to enhancing SD-WAN Customer Equipment (CE) nodes with forwarding capabilities to impose Internet Protocol version 6 (IPv6) SR header with end-to-end path information based on methods that do not require the SD-WAN CE nodes to be part of the SRv6 routing domain.

### Description of the Related Art

Segment Routing (SR) leverages the source routing paradigm. A node steers a packet through an ordered list of instructions, called “segments.” A segment can represent any instruction, topological or service based. A segment can have a semantic local to an SR node or global within an SR domain. SR provides a mechanism that allows a flow to be restricted to a specific topological path, while maintaining per-flow state only at the ingress node(s) to the SR domain.

SR can be applied to the IPv6 architecture, with a new type of routing header, called an IPv6 Extension Header (EH), an example of which is the Segment Routing Header (SRH). A given segment is encoded as an IPv6 address. An ordered list of segments is encoded as an ordered list of IPv6 addresses in the routing header (e.g., the SRH). The active segment is indicated by the Destination Address (DA) of the packet. The next active segment is indicated by a pointer in the new routing header.

### SUMMARY

Systems and methods are described for facilitating traffic steering via an SRv6 network by SD-WAN CE nodes without requiring the SD-WAN CE nodes to have SRv6 routing capabilities. According to one embodiment, an end-to-end SRv6 tunnel is established through the SRv6 network between a source SD-WAN CE node associated with a first local area network (LAN) and a destination SD-WAN CE node associated with a second LAN. LAN-side traffic originated by the first LAN and destined for the second LAN is received by the source SD-WAN CE node. Based on the LAN-side traffic, the source SD-WAN CE node, may encapsulate the LAN-side traffic as payload of an IPv6 packet, including incorporating end-to-end path information within an IPv6 SRH to instruct provider edge (PE) or provider (PE/P) nodes of the SRv6 network how to steer the IPv6 packet through the SRv6 network. Forwarding the encapsulated LAN-side traffic by the SD-WAN CE node through the SRv6 network via the SRv6 tunnel.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a high-level block diagram conceptually illustrating an operating environment in which various embodiments of the present disclosure may be employed.

FIG. 2 is a block diagram illustrating an architecture and approach for obtaining path information by a source SD-WAN CE node from a Path Computation Engine (PCE), imposition of IPv6 SRH headers, and forwarding of LAN-side traffic through an SRv6 network via an SRv6 tunnel in accordance with a first embodiment of the present disclosure.

FIG. 3 is an example of a snippet of a command syntax that may be used on an SD-WAN CE node to configure an SRv6 tunnel construct in accordance with an embodiment of the present disclosure.

FIG. 4 is an example of a snippet of command-line interface (CLI) command syntax for creating mappings of LAN-side traffic profiles to paths of an SRv6 tunnel on an SD-WAN CE node in accordance with an embodiment of the present disclosure.

FIG. 5A is an example of Representational State Transfer (REST) API Path-Request data for SRv6 path information in accordance with an embodiment of the present disclosure.

FIG. 5B is an example of REST API Path-Request data for SRv6 path information in a CE-multihoming scenario in accordance with an embodiment of the present disclosure.

FIG. 6 is an example of REST API Path-Response data for SRv6 path information in accordance with an embodiment of the present disclosure.

FIG. 7 is a high-level flow diagram illustrating a set of operations for performing traffic steering through an SRv6 network via an SRv6 tunnel in accordance with an embodiment of the present disclosure.

FIG. 8 is a block diagram illustrating an architecture and approach for obtaining path information by a source SD-WAN CE node indirectly from a PCE via a controller, imposition of IPv6 SRH headers, and forwarding of LAN-side traffic through an SRv6 network via an SRv6 tunnel in accordance with a second embodiment of the present disclosure.

FIG. 9 is a block diagram illustrating an architecture and approach for obtaining static path configuration by a source SD-WAN CE node directly from an administrator or indirectly via a CE management device, imposition of IPv6 SRH headers, and forwarding of LAN-side traffic through an SRv6 network via an SRv6 tunnel in accordance with a third embodiment of the present disclosure.

FIG. 10 is an example of a snippet of a CLI command syntax for static configuration of paths of an SRv6 tunnel on an SD-WAN CE node in accordance with an embodiment of the present disclosure.

FIG. 11 is a block diagram conceptually illustrating control-plane and forwarding-plane state diagrams for SRv6 path information maintenance in accordance with an embodiment of the present disclosure.

FIG. 12 is an example of Path-Inform data issued by a source SD-WAN CE to the SRv6 PCE in accordance with an embodiment of the present disclosure.

FIG. 13 is a block diagram illustrating overlay routing for an SRv6 tunnel between SD-WAN CEs in accordance with an embodiment of the present disclosure.

FIG. 14 is an example of a snippet of a CLI command syntax for configuring static overlay routing on an SD-WAN CE node in accordance with an embodiment of the present disclosure.

FIG. 15 is a block diagram illustrating overlay routing for an SRv6 tunnel between multi-homed SD-WAN CEs in accordance with an embodiment of the present disclosure.

FIG. 16 illustrates an example computer system in which or with which embodiments of the present disclosure may be utilized.

### DETAILED DESCRIPTION

Systems and methods are described for facilitating traffic steering via an SRv6 network by SD-WAN CE nodes without requiring the SD-WAN CE nodes to have SRv6 routing capabilities. In an SRv6 network, to steer traffic from one network edge to another network edge in accordance with the paths that correspond to performance conditions such as low-latency, high-throughput, and best-effort, the Provider Edge (PE) nodes of the SRv6 network typically are required to have full SRv6 routing information on a network-wide basis for underlay transport routing and overlay network services routing with other PE nodes across Provider (P) nodes such that the PE nodes can then encapsulate packets coming from the transmitting customer equipment (CE) nodes with an appropriate IPv6 Extension Header (EH) (e.g., an SRH) and then programmatically deliver the outer packets through the PE and P nodes to the receiving CE node.

In an SRv6 network providing next-generation SD-WAN service with SD-WAN CE nodes connected to PE nodes where the SRv6 network requires or delegates SD-WAN CE nodes to utilize the SRv6 routing information of the SRv6 network with the intention of operating the traffic steering function on these SD-WAN CE nodes instead of PE nodes as a method to reduce complexity/cost on PE nodes for example, the role of PEs is pushed on SD-WAN CE nodes with the current standard routing methods in an SRv6 network generally requiring the SD-WAN CE nodes to participate in the SRv6 routing domain in underlay transport routing and overlay network services routing, similar to PE nodes. This means that the SD-WAN CE nodes effectively become PE nodes, needing to support not only complex routing protocols such as Intermediate System to Intermediate System (IS-IS) or Open Shortest Path First version 3 (OSPFv3) with SRv6 extension for underlay routing, but also topology acquisition protocols such as BGP Link-State (BGP-LS) and path computation protocols such as BGP Segment Routing Traffic Engineering (SR-TE), SRv6 Path Computation Element communication Protocol (PCEP) for SRv6 Traffic-Engineering (TE). This brings about complex requirements for SD-WAN CE nodes which often have substantially lower computing resources than PE nodes and the fact that the SD-WAN CE nodes may only have a very small number of uplinks into PE nodes compared to the number of links that PE nodes have, making the effort of extending SD-WAN CE nodes with usual SRv6 routing capabilities extremely difficult and may not be necessary. One potential method to avoid the aforementioned complex requirements is the co-operation of PE nodes and SD-WAN CE nodes, where SD-WAN CE nodes use a Binding Segment Identifier (SID) to signal a path created and maintained by PE nodes which then map the Binding SID into a list of actual SIDs that represents a path inside the SRv6 network. However, this method still requires PE nodes to build an SRv6 tunnel and adds another layer of complexity of mapping between Binding SID and actual SIDs.

Embodiments described herein seek to avoid the aforementioned complex requirements by enhancing SD-WAN CE nodes with forwarding capabilities to impose IPv6 EH with end-to-end path information based on three new methods other than the usual method of having SRv6 routing capabilities (e.g., IS-IS or OSPFv3 with SRv6 extension, BGP-LS, BGP SR-TE or SRv6 PCEP) and other than the above-described approach of using a Binding SID. In various examples described herein there is no need for SD-WAN CE nodes to participate in the SRv6 routing domain amongst PE/P nodes; however, the SD-WAN CE nodes are still able to encode the end-to-end path instruction through the IPv6 EH to instruct the PE/P nodes how to steer traffic along the way inside the SRv6 network as if the SD-WAN CE nodes did in fact run the usual SRv6 routing protocols.

The three new methods described herein allow the SRv6 network to make SD-WAN CE nodes an SRv6-ultra-lite layer without a major software/hardware upgrade or development because there is no need to extend SD-WAN CE nodes with complex SRv6 protocols (such as IS-IS or OSPFv3 with SRv6 extension, BGP-LS, BGP SR-TE or SRv6 PCEP). Additionally, there is no need to use a Binding SID and mapping/maintaining of such Binding SID to a list of actual SIDs on PE nodes. As described further below, the three new methods that allow SD-WAN CE nodes to obtain path information for imposition in the IPv6 SRH headers for end-to-end paths include:
Method 1: A source SD-WAN CE node may obtain path information from a Path Computation Engine (an SRv6 PCE). For example, the SD-WAN CE node may make a Representational State Transfer (REST) Application Programming Interface (API) call to the Path Computation Engine (SRv6 PCE) (as defined by RFC 4655) server that supports SRv6 of the SRv6 network. In one embodiment, the SD-WAN CE nodes are network security appliances (e.g., a next-generation FORTIGATE firewall appliance available from Fortinet, Inc. of Sunnyvale, CA).
Method 2: A source SD-WAN CE node may obtain path information indirectly from the SRv6 PCE via a controller managing the source SD-WAN CE node (and potentially one or more other SD-WAN CE nodes) and operating in the role of an SD-WAN Element/Policy Management System (E/PMS). For example, the controller may periodically make a REST API call to the SRv6 PCE server of the SRv6 network. The controller then updates the SD-WAN CE node(s) configured with SRv6 tunnels with the path information obtained from SRv6 PCE. In one embodiment, the controller may represent a network security appliance management device (e.g., one of the FORTIMANAGER family of management appliances) with the management device taking the E/PMS role, and communicating with the SD-WAN CE nodes via a management protocol (e.g., the FORTGATE to FORTIMANAGER (FGFM) protocol) for the implementation of path instruction.
Method 3: A source SD-WAN CE node may be configured with a static path configuration.

While various examples herein may be described with reference to the use of a specific IPv6 EH format (i.e., an SRH), it is to be appreciated various other IPv6 EH formats may be used. As such, the specific references to SRH should be taken as illustrative only.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

The term “client” generally refers to an application, program, process or device in a client/server relationship that requests information or services from another program, process or device (a server) on a network. Importantly, the terms “client” and “server” are relative since an application may be a client to one application but a server to another. The term “client” also encompasses software that makes the connection between a requesting application, program, process or device to a server possible, such as a file transfer protocol (FTP) client.

As used herein, a “network security appliance” or a “network security device” generally refers to a device or appliance in virtual or physical form that is operable to perform one or more security functions. A network security device may reside within the particular network that it is protecting, or network security may be provided as a service with the network security device residing in the cloud. Some network security devices may be implemented as general-purpose computers or servers with appropriate software operable to perform one or more security functions. Other network security devices may also include custom hardware (e.g., one or more custom Application-Specific Integrated Circuits (ASICs)). For example, while there are differences among network security device vendors, network security devices may be classified into three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines one or more CPUs, CPs, NPs. Mid-range network security devices may include one or more multi-core CPUs, one or more separate NP Application-Specific Integrated Circuits (ASICs), and one or more separate CP ASICs. At the high-end, network security devices may have multiple NPs and/or multiple CPs. A network security device is typically associated with a particular network (e.g., a private enterprise network) on behalf of which it provides one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VOIP) support, Virtual Private Networking (VPN), data loss prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DOS attack detection appliances (e.g., the FORTIDDOS family of DOS attack detection and mitigation appliances).

As used herein, an “Internet Protocol version 6 Extension Header” or IPv6 EH” generally refers to one of the various IPv6 EH formats defined by standard and/or draft Requests for Comments (RFCs), including but not limited to:
IPv6 Segment Routing Header (SRH) as defined in RFC 8754, which is hereby incorporated by reference in its entirety for all purposes.
IPv6 Compressed SRv6 (C-SRH) as defined in draft RFC: https://datatracker.ietf.org/doc/draft-li-spring-compressed-srv6-np/, which is hereby incorporated by reference in its entirety for all purposes.
IPv6 Compressed Routing Header (CRH) defined in draft RFC: https://datatracker.ietf.org/doc/draft-ietf-6man-comp-rtg-hdr/, which is hereby incorporated by reference in its entirety for all purposes.
SRv6 uSID Instruction defined in draft RFC: https://datatracker.ietf.org/doc/draft-filsfils-spring-net-pgm-extension-srv6-usid/, which is hereby incorporated by reference in its entirety for all purposes.

As used herein, an “end-to-end Segment Routing over Internet Protocol version 6 tunnel” or an “end-to-end SRv6 tunnel” generally refers to a tunnel between SD-WAN CE nodes through an SRv6 network in which a source SD-WAN CE node encapsulates LAN-side traffic within IPv6 packet payloads and adds segment identifier (SID) information to an IPv6 EH (e.g., an SRH) of such IPv6 packets. In various examples described herein, the use of an IPv6 EH by a source SD-WAN CE node to steer traffic through an SRv6 tunnel is described with reference to the use of an SRH; however, it is to be appreciated the traffic steering techniques described herein are generally applicable to other IPv6 EH formats.

As used herein, “Segment Routing over Internet Protocol version 6 routing capabilities” or “SRv6 routing capabilities” generally refer to implementation of various protocols (e.g., IS-IS or OSPFv3 with SRv6 extension, BGP-LS, BGP SR-TE or SRv6 PCEP) that are typically implemented by an SRv6 routing domain.

As used herein, a “a Software-Defined Wide Area Networking Customer Equipment (CE) node” or an “SD-WAN CE node” generally refers to a network device associated with or located within a customer's network. In various examples described herein, SD-WAN CE nodes may be network security appliances (e.g., next-generation firewall appliances or UTM appliances).

As used herein, a “Provider Edge node” or “PE node” generally refers to a network device (e.g., a router) that is located at a provider network (e.g., an SRv6 network) and that is connected to a CE node (e.g., an SD-WAN CE node) associated with a customer premises.

As used herein, a “Provider node” or “P node” generally refers to a network device (e.g., a router) that is located in the core of the provider's network.

As used herein, a Provider Edge or Provider node” or a “P/PE node” generally refers to either a PE node or a P node.

As used herein, “path information” generally refers to a Segment-List (e.g., a collection of Segment-IDs or SIDs), corresponding to a network path, instructing PE/P nodes of an SRv6 network how to forward the outer IPv6 packet. Non-limiting examples of network paths are best-effort path, low-latency path, bandwidth-assured path.

As used herein, a “controller” generally refers to a device that manages and/or controls one or more CE nodes (e.g., SD-WAN CE nodes) and that performs the role of an SD-WAN network Element/Policy Management System (E/PMS) under the administration or co-operating with an SRv6 network.

### Overview

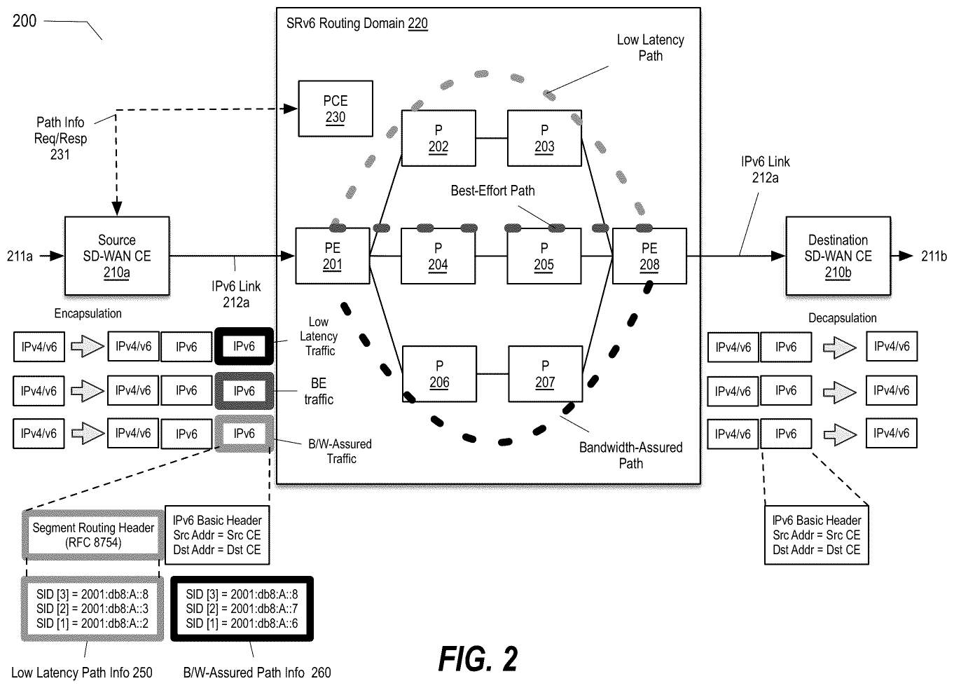

SD-WAN CE nodes classify LAN-side traffic (IPv4 or IPv6 packets) based on predefined criteria, for example, 5 tuples (source/destination IP addresses, source/destination ports, Differentiated Services Code Point (DSCP)/IP Precedence values) and encapsulates the LAN-side traffic as payload in an outer IPv6 packet with the header of the outer IPv6 packet encoded with end-to-end path information for the next Provider/Provider Edge (P/PE) nodes of the SRv6 network regarding how to forward the outer IPv6 packet. Each 5-tuple combination may define a LAN-side traffic profile. As depicted in FIG. 2, the source SD-WAN CE node encapsulates LAN-side traffic within an outer IP packet having up to two IPv6 header levels:
The first (top) header level, which has an IPv6 basic header and an IPv6 extension header being IPv6 SRH (RFC 8754) that contains path information. In the IPv6 basic header of this level:
   The Source Address field is the IPv6 address of the transmitting SD-WAN CE node (which may also be referred to herein as the source SD-WAN CE node).
   The Destination Address field is the first SRv6 SID in the Segment-List.
   The Next Header field should have an appropriate value to indicate the IPv6 SRH as per RFC 8200.
The IPv6 SRH in the first (top) header level should have an appropriate value (as per RFC 8200) in its own Next Header field to indicate the second header level of an inner IPv6 packet.
The second header level, which has an IPv6 basic header allows for delivering the traffic throughout the SRv6 domain via SRv6 Best Effort (BE) path. In this header:
   The Source Address field is the IPv6 address of the transmitting (or source) SD-WAN CE node.
   The Destination Address field is the IPv6 address of the receiving SD-WAN CE node (which may also be referred to herein as the destination SD-WAN CE node).
   The Flow Label field is set to the value of the color value corresponding to the LAN-side traffic profile configured on the source SD-WAN CE node, or value of 0 if no color is defined. This will assist the receiving (or destination) SD-WAN CE node in mapping between the arriving IPv6 packet and the path.
   Depending on the LAN-side traffic type, e.g. IPv4 or IPv6, the Next Header field value of the second header level should have an appropriate value to indicate the inner payload as per RFC 8200.

LAN-side traffic intended to traverse the SRv6 domain via SRv6 Traffic-Engineering (TE) paths is encapsulated with both IPv6 header levels. On the other hand, LAN-side traffic intended to traverse the SRv6 domain via SRv6 Best-Effort (BE) paths is encapsulated with only one IPv6 header level being the second header level.

The last PE node of the SRv6 routing domain can implement an Ultimate Segment Decapsulate (USD) flavor specified in RFC 8986 and therefore remove only the first (top) header level, delivering the inner IPv6 packet to the Destination SD-WAN CE node.

In the future, if and when SRv6 technology and/or industry standards allow for specifying an IPv6 address in the last Segment of the Segment-List in addition to the current SRv6 SID format (Locator, Function), the second header level could be omitted to reduce encapsulation overhead for packets going via SRv6 TE paths as the IPv6 address of the destination SD-WAN CE node can be placed in the last Segment. In this hypothetical case, the source SD-WAN CE may then impose only the first (top) header level.

Hardware logic (e.g., an ASIC chip in the SD-WAN CE nodes) may be used to support SRv6 forwarding capabilities by the SD-WAN CE nodes, including parsing and processing of IPv6 packets with SRv6 headers. The packet processing pipeline should include components for packet parsing, IPv6 EH (e.g., SRH) extraction, lookup operation(s) and packet modification(s) in order to ensure SRv6 headers are correctly processed and forwarded according to the specified Segment-List. The design of the hardware logic is outside of the scope of the present disclosure, which assumes that this hardware layer is available to be used and directed by the control-plane or software layer of the SD-WAN CE nodes.

In various embodiments described herein, despite the IPv6 EH (e.g., SRH) being used in the forwarding-plane of the SD-WAN CE nodes, they are not assigned their own SRv6 endpoint SIDs in the control-plane as they do not participate in the SRv6 routing domain using any current standard method. As described herein, an SD-WAN CE node can simply use the directly connected PE nodes as its default gateway(s) to reach all other SD-WAN CE nodes. An SD-WAN CE node can implement any usual tracking mechanism to track the reachability of its default gateway(s).

### Example Operating Environment

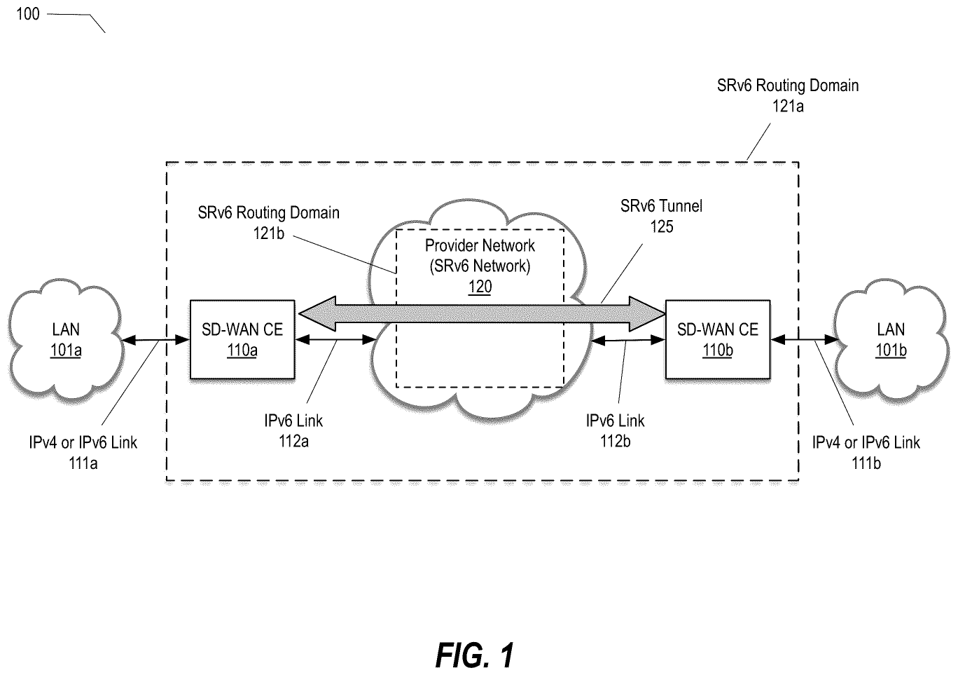

FIG. 1 is a high-level block diagram conceptually illustrating an operating environment 100 in which various embodiments of the present disclosure may be employed. In the context of the present example, SD-WAN CE nodes (e.g., SD-WAN CE nodes 110a and 110b) establish an SRv6 tunnel (e.g., SRv6 tunnel 125) through a provider network (e.g., provider network 120, representing an SRv6 network). The SD-WAN CE nodes are network devices, for example, they may be routers. In one embodiment, the SD-WAN CE nodes are network security appliances (e.g., next-generation firewall appliances or UTM appliances). While the SD-WAN CE nodes may perform other functions, for example, network security functions to protect their respective LANs (e.g. LANs 101a and 101b), with respect to the SRv6 network 120 to which they are connected via respective IPv6 links (e.g., IPv6 link 112a and 112b), the SD-WAN CE nodes operate as tunnel endpoints, in which the SD-WAN CE nodes (when representing a source SD-WAN CE node) receive LAN-side traffic from their respective LANs via respective IPv4 or IPv6 links (e.g., IPv4 or IPv6 links 111a and 111b), encapsulate the LAN-side traffic within an outer IPv6 packet (as described further below) when the LAN-side traffic is to be forwarded via the SRv6 tunnel, and forward the encapsulated LAN-side traffic to the destination SD-WAN CE node. When representing a destination SD-WAN CE node, the SD-WAN CE node may decapsulate the tunneled traffic received from the source SD-WAN CE node (to the extent not already done so at the egress of the SRv6 routing domain 121b) and direct the tunneled traffic to the LAN with which it is associated.

For purposes of clarity, it is noted that LANs 101a and 101b may represent geographically distributed portions of an enterprise network (e.g., a LAN of a branch office, a LAN of a headquarters office, etc.) and each LAN may include multiple networks and/or include or represent a cloud (e.g., a private cloud, a public cloud, or a hybrid cloud).

As noted above, rather than exposing the SD-WAN CE nodes to the complexities of the SRv6 routing capabilities as currently expected by existing implementations and thereby expanding the routing domain of the SRv6 network to SRv6 routing domain 121a, embodiments of the present disclosure propose limiting the routing domain of the SRv6 network to SRv6 routing domain 121b. In this manner, SD-WAN CE nodes need not be assigned SIDs and need not implement SRv6 routing capabilities, such as IS-IS or OSPFv3 with SRv6 extension, BGP-LS, BGP SR-TE or SRv6 PCEP.

While in the context of this simplified example, only two LANs, two SD-WAN CE nodes, one intermediate network, and one SRv6 tunnel is shown, it is to be appreciated additional LANs, SD-WAN CE node pairs, intermediate networks (of the same or different types), and SRv6 tunnels between respective SD-WAN CE node pairs may exist and be utilized to support a given environment.

### Reference SRv6 Network Topology and First Example of Path Information Obtainment

FIG. 2 is a block diagram illustrating an architecture 200 and approach for obtaining path information by a source SD-WAN CE node 210a from a Path Computation Engine or Element (PCE) 230, imposition of IPv6 SRH headers, and forwarding of LAN-side traffic through an SRv6 network via an SRv6 tunnel in accordance with a first embodiment of the present disclosure. In the context of the current example, a reference topology for an SRv6 routing domain 220 (which may be analogous to SRv6 routing domain 121b) is shown that will be used in various examples described herein.

In this example, the SRv6 routing domain 220 is shown including an SRv6 PCE (e.g., PCE 230) and a number of PE/P nodes, including PE nodes 201 and 208, and P nodes 202-207. The SRv6 PCE is expected to be compatible with RFC 4655 (which is hereby incorporated by reference in its entirety for all purposes), and may perform, among other things, topology acquisition via BGP-LS (e.g., RFC 7752) and path computation.

For purposes of the present example, it is assumed there are traffic streams (e.g., inbound LAN-side traffic 211a) going from a first LAN (e.g., LAN 101a) to a second LAN (e.g., LAN 101b in the form of outbound LAN-side traffic 211b) that traverse the SD-WAN CE nodes (e.g., source SD-WAN CE node 210a, which may be analogous to SD-WAN CE node 110a and destination SD-WAN CE node 210b, which may be analogous to SD-WAN CE node 110b) and an SRv6 network (e.g., SRv6 network 120) as the intermediate network. The source and destination SD-WAN CE nodes 210a and 210b are connected to PE nodes 201 and 208, respectively. There are three network paths (e.g., (i) a low latency path, depicted as a light gray, dashed line passing through PE/P nodes 201, 202, 203, and 208; (ii) a best-effort path, depicted as a dark gray, dashed line passing through PE/P nodes 201, 204, 205, and 208; and (iii) a bandwidth-assured path depicted as a black, dashed line passing through PE/P nodes 201, 206, 207, and 208) between PE nodes 201 and 208 in the SRv6 network. In various examples described herein, the SD-WAN CE nodes steer respective traffic into the different paths without participating in the SRv6 routing domain 220 (meaning, among other things, the SD-WAN CE nodes need not be configured with end SIDs)

The source SD-WAN CE 210a encapsulates LAN-side traffic within outer IPv6 packets (e.g., SRv6 tunnel 125) that have both an IPv6 basic header and an IPv6 EH, which in the context of the present example is the IPv6 SRH (RFC 8754) and includes either low latency path information 250, bandwidth-assured path information 260, or no path information (for the best-effort path). In this scenario, there are three LAN-side traffic-profiles:
LAN-side traffic matching the criteria for the best-effort path.
LAN-side traffic matching the criteria for the low-latency path.
LAN-side traffic matching the criteria for the bandwidth-assured path.

In this example, the source SD-WAN CE node 210a steers different LAN-side traffic matching these LAN-side traffic profiles in different paths by imposing an IPv6 SRH header (RFC 8754) containing specific path information for each path by utilizing path information obtained in accordance with one of three exemplary methods without participating in the SRv6 routing domain. As noted above, path information may be obtained in at least the following three different ways (referred to herein as “Method 1,” “Method 2,” and “Method 3”) and which are summarized below for ease of reference:
Method 1: The source SD-WAN CE node 210a may obtain path information directly from the PCE 230, for example, via a REST API method exposed by the PCE 230.
Method 2: The source SD-WAN CE node 210a may obtain path information indirectly from the PCE 230 via a controller managing the source SD-WAN CE node (and potentially one or more other SD-WAN CE nodes) and operating in the role of an E/PMS), which in turn obtains the path information on behalf of one or more managed SD-WAN CE nodes. Depending on the particular implementation, the path information may be pulled by the source SD-WAN CE node 210a from the controller or pushed to the source SD-WAN CE node 210a from the controller.
Method 3: The source SD-WAN CE node 210 may be configured with a static path configuration.

As SD-WAN CE nodes do not participate in the SRv6 routing domain 220, the SD-WAN CE nodes represent an SRv6-ultra-lite layer without requiring a major software/hardware upgrade or development because there is no need to develop SD-WAN CE nodes with complex SRv6 protocols, such as IS-IS or OSPFv3 with SRv6 extension, BGP-LS, BGP SR-TE or SRv6 PCEP.

While in the context of the present example, the traffic streams are described in one direction for brevity, it is to be understood an SD-WAN CE node can be both a “source” and a “destination” SD-WAN CE node at the same time as traffic is generally bidirectional.

Method 1 will now be described with continuing reference to the present example and FIG. 2. As noted above, the SRv6 network is deployed with a SRv6 PCE server (e.g., PCE 230 that frequently acquires network topology, and live resources via BGP/IGP-LS, and then computes paths between each pair of PE nodes 201 and 208.

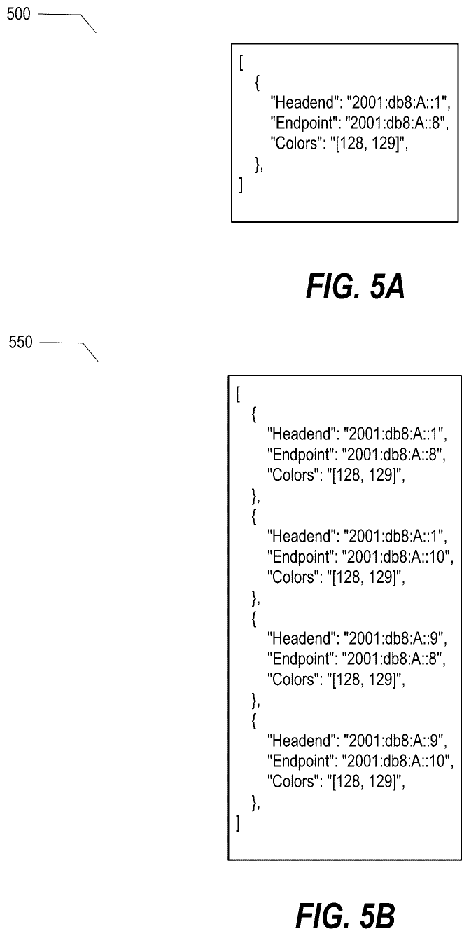

On each SD-WAN CE node 210a and 210b, the SRv6 network administrator is expected to pre-configure the Endpoint SID values of the PE node(s) that the local SD-WAN CE directly connects with, the Endpoint SID values of the remote PE node(s) connected with the remote SD-WAN CE nodes, and the LAN-side traffic-profiles represented by color. As per RFC 9256, the “color” is an unsigned non-zero 32-bit integer value that associates the SR Policy with an intent or objective (e.g., low latency). The source SD-WAN CE node 210a may then issues a request for path information, for example, in the form of a RESTful API Path-Request to the PCE 230 to ask for all SRv6 Traffic-Engineering (TE) policies required or designed by the SRv6 network administrator between source and destination SD-WAN CE nodes 210a and 210b. A non-limiting example of a Path-Request data that may be issued by the source SD-WAN CE node 210a asking the PCE 230 for all SRv6 policies between two SRv6 End SIDs is described below with reference to FIG. 5A.

At this point it may be instructive to explain an example for a proposed SRv6 tunnel construct that may be used on the source SD-WAN CE node 210a.

### Underlay Forwarding, SRv6 Tunnel

With the outer IPv6 packets, the source and destination SD-WAN CE nodes 210a and 210b effectively form an IPv6 tunnel (e.g., SRv6 tunnel 125) that carries LAN-side traffic inside. This IPv6 tunnel has multiple paths for multiple LAN-side traffic profiles. The PE/P nodes of the SRv6 network are only required to provide basic IPv6 routing of the outer IPv6 packets for the SD-WAN CE nodes to reach each other by redistributing the network(s) of the PE-CE interface(s) into the SRv6 routing domain 220 in order to advertise the IPv6 address prefixes of SD-WAN CE nodes. The P/PE nodes are not required to route or inspect the inner LAN-side packets. The IPv6 tunnel between the SD-WAN CE nodes can be either unencrypted like an IPv6 Generic Routing Encapsulation (GRE) tunnel or encrypted like an IPv6 Internet Protocol Security (IPSec) VPN tunnel.

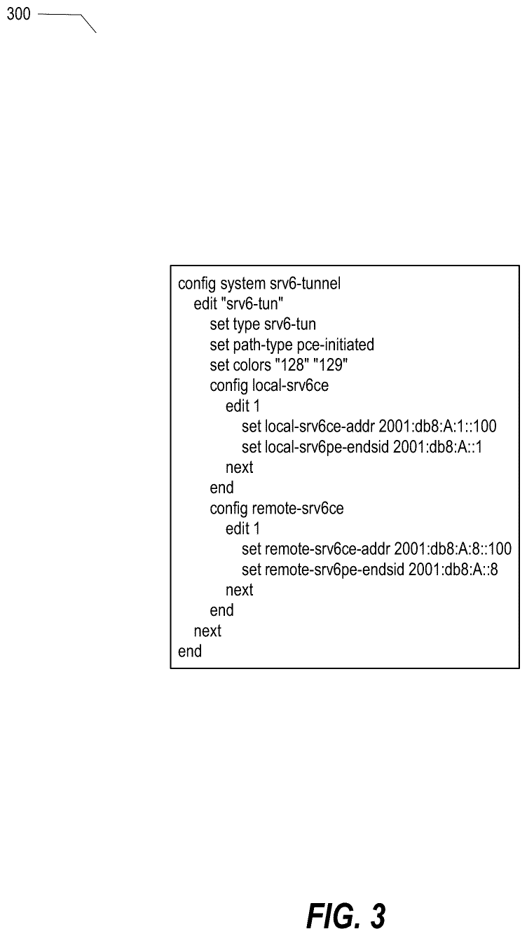

Turning now to FIG. 3, an example of a snippet 300 of a command syntax that may be used on an SD-WAN CE node to configure an SRv6 tunnel construct in accordance with an embodiment of the present disclosure is described. The non-limiting example snippet 300 suggests that the SRv6 tunnel 125 is a multipoint tunnel where it is possible to specify multiple pairs of source and destination SD-WAN CE nodes in the same tunnel construct. It is worth noting that the value associated with the “local-srv6ce-addr” field should be an IPv6 address configured on the local SD-WAN CE, and typically on the uplink interface towards the local PE node.

Below is an explanation of the values specified in snippet 300:
2001:db8:A:1::100 is the source IPv6 address of the source SD-WAN CE node (e.g., source SD-WAN CE node 210b).
2001:db8:A:8::100 is destination IPv6 address of the destination SD-WAN CE node (e.g., destination SD-WAN CE node 210b).
2001:db8:A::1 is the SRv6 Endpoint SID of the source PE node (e.g., PE node 201).
2001:db8:A::8 is the SRv6 Endpoint SID of the destination PE node (e.g., PE node 208).
The “colors” values of 128 and 129 correspond to the two LAN-side traffic-profiles.
The “pce-initiated” statement means that the SRv6 tunnel will have its path information obtained from a SRv6 PCE of the SRv6 network.

### Underlay Forwarding, Traffic Mapping to SRv6 Tunnel

Upon receiving the LAN-side traffic (inner IPv4/IPv6 packets), the source SD-WAN CE node 210a determines the destination SD-WAN CE node 210b by using an overlay routing method to route the LAN-side traffic based on the IPv4/IPv6 destination address field so that the LAN-side traffic can be forwarded to the correct SRv6 tunnel. The methods for overlay routing will be discussed further below.

This portion of the disclosure discusses the step after the overlay routing has already occurred. For example, as in how LAN-side traffic-profiles are determined to be going to a specific SRv6 tunnel can be mapped to the respective paths (e.g., low-latency path, best-effort path, or bandwidth-assured path) of that SRv6 tunnel. For purposes of providing a concrete example, this portion of the disclosure continues to use the reference topology depicted in FIG. 2.

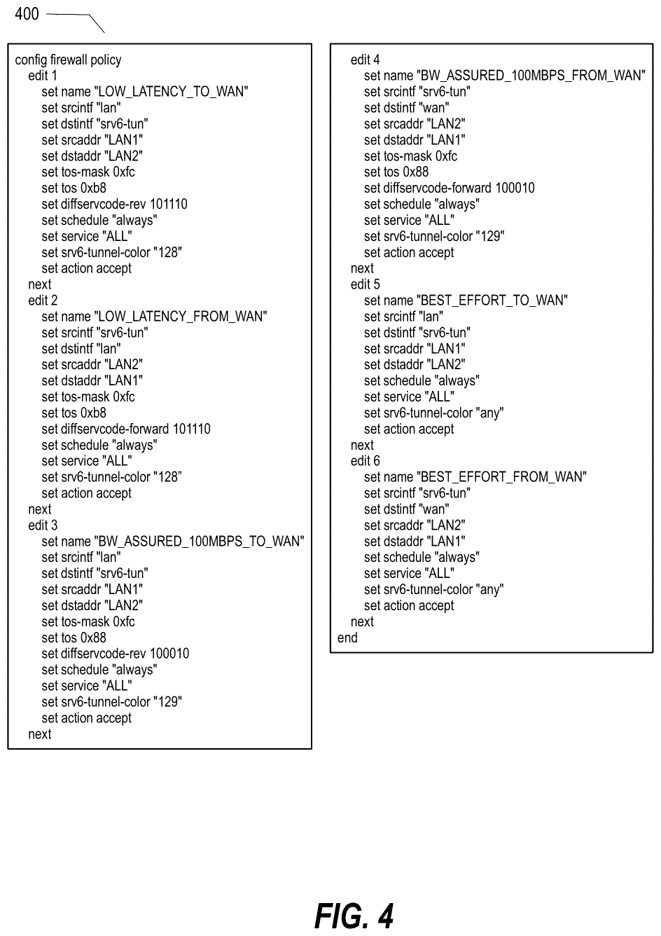

FIG. 4 is an example of a snippet 400 of command-line interface (CLI) command syntax for creating mappings of LAN-side traffic profiles to paths of an SRv6 tunnel on an SD-WAN CE node in accordance with an embodiment of the present disclosure. The non-limiting example CLI configuration snippet 400 shown in FIG. 4 includes new command syntaxes that may be used on SD-WAN CE nodes for the mapping of three LAN-side traffic-profiles (e.g., low-latency, bandwidth-assured and best-effort) to three paths of an SRv6 tunnel on the source SD-WAN CE 210a of the reference topology in FIG. 2. The actual command syntax may vary based on the vendor of the SD-WAN CE node at issue.

In the context of FIG. 4, rule “1” maps LAN-side traffic going from “lan” interface with a specific combination of 5 tuples to an SRv6 tunnel named “srv6-tun” with color “128” that signified the “low-latency” path as defined by the PCE 230 or the network administrator. Rule “1” also establishes (i) source and destination address groups named “LAN1” and “LAN2” containing one or more IPv4/IPv6 prefixes for the local and remote LAN networks respectively, (ii) source/destination port range group named “ALL,” and (iii) ToS value of “0xb8” and DSCP code of “101110”.

The next rule, rule “2” is the reverse mapping rule for incoming “low-latency” traffic from the “srv6-tun” interface to the “lan” interface, matching the same 5 tuples with just a swap of source and destination interface fields. Following the same logic, rules “3” and “4” are used to map “bandwidth-assured” traffic between “lan” and “srv6-tun” with color “129” that signified “bandwidth-assured” path as defined by the SRv6 PCE or the network administrator. As can be seen from a snippet 400, the last two rules “5” and “6” do not have any color as they map “best-effort” traffic into a “best-effort” path of the SRv6 tunnel.

### Underlay Forwarding, SRv6 Path Types

### Best-Effort Path

The SRv6 Best-Effort (BE) path of the SRv6 tunnel is used to forward traffic in any possible loop-free route between the source and destination SD-WAN CE nodes 210a and 210b by relying on the IPv6 routing protocol of the SRv6 network amongst P/PE nodes. With SRv6 BE path, the LAN-side traffic is encapsulated with an outer IPv6 header (SRv6 tunnel) that does not need to have an IPv6 SRH imposed. This is because this outer IPv6 packet can be routed simply based on the regular IPv6 destination-based routing of the IPv6 routing protocol within the SRv6 network. As noted above, the best-effort path in FIG. 2 for the SRv6 tunnel between the source and destination SD-WAN CE nodes 210a and 210b is depicted as a dark gray, dashed line passing through PE/P nodes 201, 204, 205, and 208.

The SRv6 Best-Effort (BE) path can be used as the default path for all traffic upon establishment of SRv6 tunnels between the SD-WAN CE nodes. This path can also be used as a fallback path if no traffic-engineered path is set or reachable. This is to ensure traffic continuity in scenarios whereby the traffic-engineered paths initiated either remotely by the PCE 230 or locally by an SRv6 network administrator become unreachable (verified through a path reachability mechanism as described further below).

### Traffic-Engineered Paths

SRv6 Traffic-Engineered (TE) paths are used to steer traffic throughout the SRv6 routing domain in accordance with the intent of the SRv6 network. In the context of the present example, there are two types of traffic-engineered paths:
SRv6 PCE-initiated: the paths that are obtained from PCE 230 of the SRv6 network.
Locally-initiated: the paths that are locally configured by an SRv6 network administrator.

Regardless of the types, SRv6 TE paths will have path instruction encoded in the SRv6 SRH header. Continuing with the present example, if the LAN-side traffic matches the criteria for the low-latency path (depicted as a light gray, dashed line passing through PE/P nodes 201, 202, 203, and 208 in FIG. 2), the matched packets are encapsulated with an outer IPv6 header (SRv6 tunnel) whose IPv6 SRH is written with a Segment-List comprising of values that correspond to the path PE node 201-P node 202-P node 2033-PE node 208. In this example:
SID[1] value is 2001:db8:A::2 which is the End SID value configured on P node 202.
SID[2] value is 2001:db8:A::3 which is the End SID value configured on P node 203.
SID[3] value is 2001:db8:A::8 which is the End SID value configured on PE node 208.

Continuing with the present example, if the LAN-side traffic matches the criteria for bandwidth-assured path (depicted as a black, dashed line passing through PE/P nodes 201, 206, 207, and 208), the matched packets are encapsulated with an outer IPv6 header (SRv6 tunnel) whose IPv6 SRH is written with a Segment-List comprising of values that correspond to the path PE node 201-P node 206-P node 207-PE node 208. In this example:
SID[1] value is 2001:db8:A::6 which is the End SID value configured on P node 206.
SID[2] value is 2001:db8:A::7 which is the End SID value configured on P node 207.
SID[3] value is 2001:db8:A::8 which is the End SID value configured on PE node 208.

### Underlay Forwarding, Path Obtainment

Each traffic-engineered (non-best-effort) path corresponds to an administratively defined performance condition, instructing PE/P nodes of the SRv6 network how to forward the outer IPv6 packets based on IPv6 SRH headers.

The three non-limiting methods described herein allow SD-WAN CE nodes to obtain path information for the imposition of the IPv6 SRH headers, for example, either via RESTful API or static configuration, instead of using standard complex SRv6 protocols such as IS-IS or OSPFv3 with SRv6 extension, BGP-LS, BGP SR-TE or SRv6 PCEP. The two methods that may utilize RESTful API will be described first.

### Underlay Forwarding, Method 1 (e.g., RESTful API Path-Request/Response Between SD-WAN CE Nodes and SRv6 PCE)

With continuing reference to FIG. 2, an example of Method 1 is described whereby the source SD-WAN CE 210a issues a Path-Request (e.g., a RESTful API Path-Request) to the PCE 230, asking for all SRv6 Traffic-Engineering (TE) policies required or designed by the SRv6 network administrator between Source and Destination PE nodes (e.g., PE nodes 201 and 208) that the SD-WAN CE nodes connect to. The source SD-WAN CE node 210a then applies the obtained path information to the LAN-side traffic-profiles accordingly.

As noted above, in the context of the present example, the SRv6 network administrator is expected to pre-configure the Endpoint SID values of the PE node(s) that the local SD-WAN CE node directly connects with, the Endpoint SID values of the remote PE node(s) connected with the remote SD-WAN CE nodes, and the LAN-side traffic-profiles represented by colors. The source SD-WAN CE node 210a may make use of the pre-configured information to issue the Path-Request to the PCE 230 to ask for all SRv6 Traffic-Engineering (TE) policies required or designed by the SRv6 network administrator between source and destination SD-WAN CE nodes 210a and 210b.

FIG. 5A is an example of Representational State Transfer (REST) API Path-Request data 500 for SRv6 path information in accordance with an embodiment of the present disclosure. In the context of the present example, the REST API Path-Request data 500 is presented in the form of a JavaScript Object Notation (JSON) expression. Those skilled in the art will appreciate other representations may be used. In this example, the Path-Request issued by the source SD-WAN CE node 210a is asking the PCE 230 for all SRv6 policies between two SRv6 End SIDs “2001:db8:A::1” and “2001:db8:A::8” of the PE nodes 201 and 208, respectively with two color codes 128 and 129 preconfigured on the source SD-WAN CE node 210a.

It is to be appreciated, the exact API syntax accepted can be detailed by SRv6 PCE nodes supporting SRv6 Traffic-Engineering in the industry following the structure defined by relevant RFCs, such as RFC 9256. The exact API syntax however is outside of the scope of this disclosure and only mentioned here for completeness and clarity. It is to be noted, the destination SD-WAN CE node 210b may have different color codes; however, it is recommended that similar color codes be used on both the source SD-WAN CE node 210a and the destination SD-WAN CD node 210b to ensure consistent behavior for two-way traffic streams.

The source SD-WAN CE node 210a should implement a retry mechanism to re-attempt RESTful API Path-Requests should there is no RESTful API Path-Response from the PCE 230 due to various reasons such as packet-loss for the network connectivity between the two entities as they are likely not in the same network.

In a CE-multihoming scenario where either or both of the source/destination SD-WAN CE nodes (210a/210b) connect to multiple PE nodes, the SD-WAN CE nodes may request for all combinations of Headend and Endpoint.

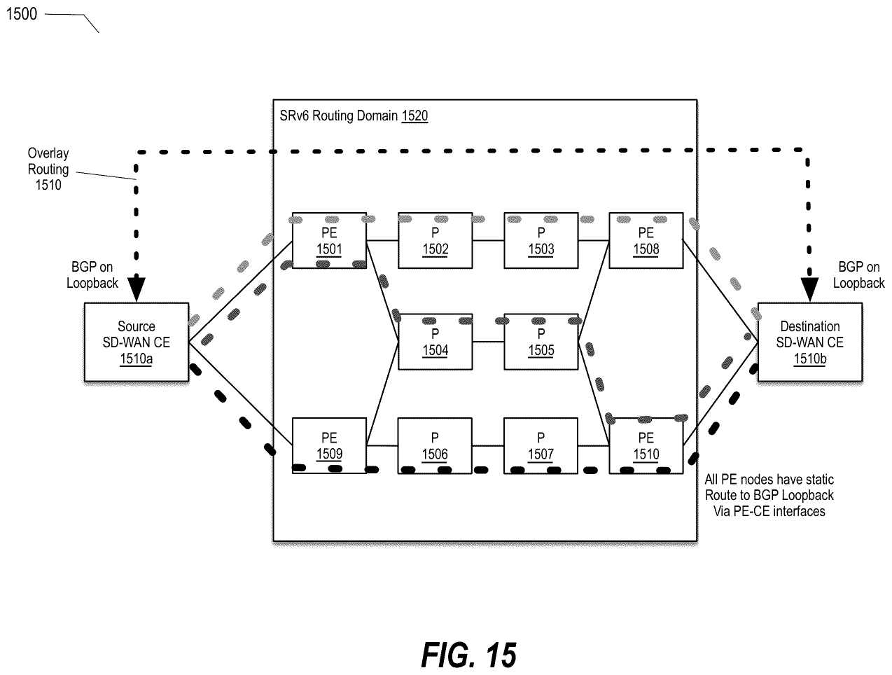

FIG. 5B is an example of REST API Path-Request data 550 for SRv6 path information in a CE-multihoming scenario in accordance with an embodiment of the present disclosure. The JSON expression depicted in FIG. 5B is intended as a non-limiting example of REST API Path-Request data 550 for a scenario in which a source SD-WAN CE node (e.g., 1510a of FIG. 15 connects to multiple PE nodes (e.g., PE node 1501 and PE node 1509 of FIG. 15 and the destination SD-WAN CE node 1510b of FIG. 15 connects to multiple PE nodes (e.g., PE node 1508 and PE node 1510, which have End SID values of 2001:db8:A::9 and 2001:db8:A::10, respectively.

With uplinks to multiple PE nodes, the source SD-WAN CE node 210a might implement equal-cost multi-path (ECMP) load-balancing to the PE nodes. This load-balancing is independent of the SRv6 routing domain and the PCE 230. Depending on which of the multiple PE nodes is chosen by the ECMP algorithm/setting on the SD-WAN CE nodes, the outer IPv6 packet is imposed with the respective Segment-List obtained from the SRv6 PCE.

The SRv6 TE policies are defined on the PCE 230 and follow the structure defined in RFC 9256. The source SD-WAN CE nodes use fields in each obtained SRv6 TE policy to impose IPv6 SRH on the respective LAN-side traffic-profiles. Below are examples of relevant fields:
Headend: the Endpoint SID of the source PE.
Endpoint: the Endpoint SID of the destination PE.
Color: the value that differentiates LAN-side traffic-profiles, for example: 128 for low-latency, 129 for bandwidth-assured (e.g., 100 Mbps).
Candidate Path: one or multiple paths with different preferences.
Segment-List: list of SIDs to be imposed in the IPv6 SRH header.

As per RFC 9256, in an SRv6 TE policy, there might be multiple paths associated with a color, differentiating by preference value. The source SD-WAN CE node 210a may choose the path with the highest preference value as the primary one and stores other paths in memory until the primary path's reachability is declared down.

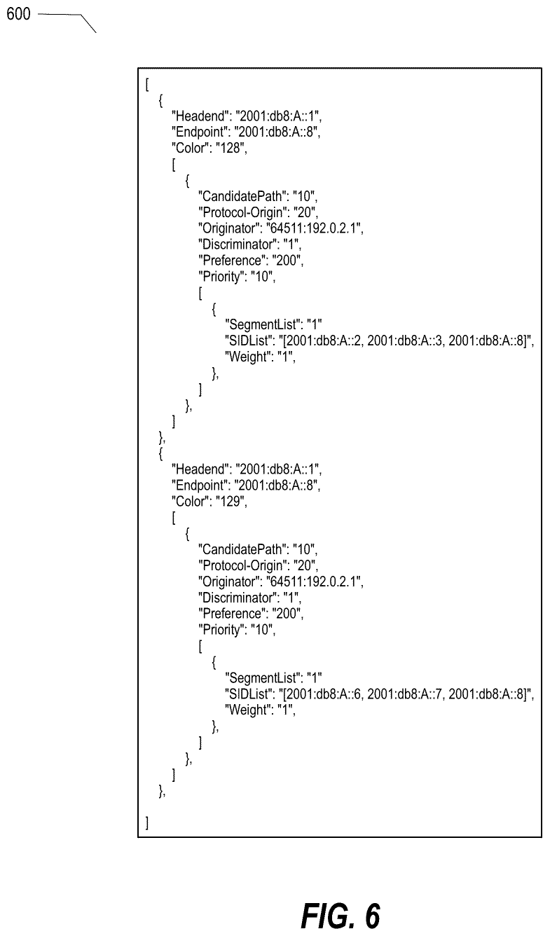

FIG. 6 is an example of REST API Path-Response data 600 for SRv6 path information in accordance with an embodiment of the present disclosure. In the context of the present example, the REST API Path-Response data 600 is presented in the form of a JSON expression and represents an example of a response from the PCE 230 to a Path-Request (e.g., a REST API Path-Request from source SD-WAN CE node 210a). The REST API Path-Response data 600 depicted in FIG. 6 is based on the structure defined in section 2.13 of RFC 9256. The source SD-WAN CE node 210a does not need to provide support for all the fields in the REST API Path-Response data 600. As above, the exact API syntax that might ultimately be implemented is outside of the scope of this disclosure is only mentioned here for completeness and clarity.

Since the SRv6 path information can be updated/fine-tuned by the PCE 230 in a dynamic or static manner, respectively by the SRv6 network (network topology/available resource changes notified via BGP-LS) or by the SRv6 network administrator, the SD-WAN CE nodes should maintain a database of all relevant information in memory for the purpose of tracking their states and displaying to users via a CLI and/or a web user interface (UI).

While it is possible for the path(s) sourced from the destination SD-WAN CE node 210b to be different from the ones sourced from source SD-WAN CE node 210a, it is recommended that forward and reverse paths are symmetric in order to ensure consistent behavior for two-way traffic streams.

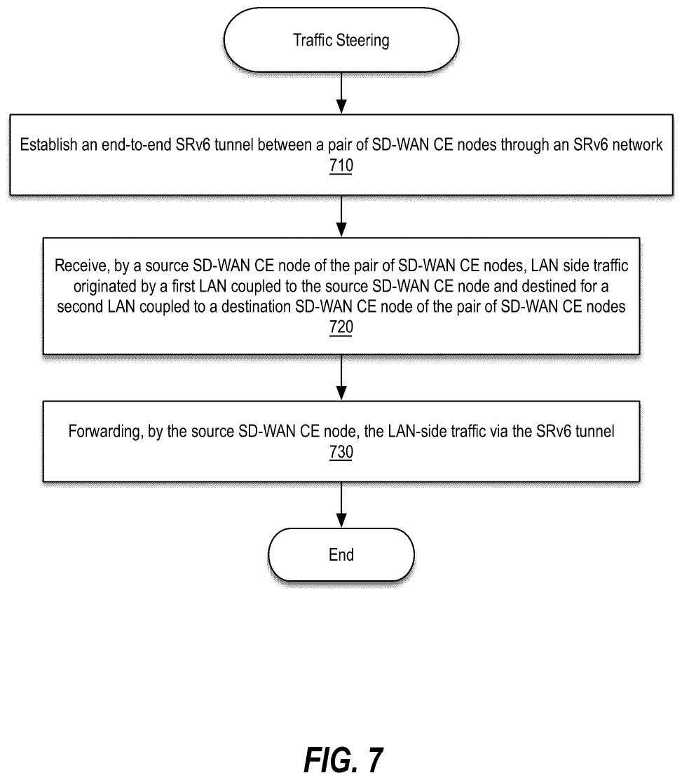

Before moving on to a discussion regarding Method 2 and Method 3, a high-level traffic steering workflow is described with reference to FIG. 7.

### Example Generalized Traffic Steering Flow

FIG. 7 is a high-level flow diagram illustrating a set of operations for performing traffic steering through an SRv6 network via an SRv6 tunnel in accordance with an embodiment of the present disclosure. The processing described with reference to FIG. 7 may be performed by a source SD-WAN CE node (e.g., source SD-WAN CE node 210a).

At block 710, an end-to-end SRv6 tunnel is established between a pair of SD-WAN CE nodes, including a source SD-WAN CE node (e.g., source SD-WAN CE node 210a) and a destination SD-WAN CE node (e.g., destination SD-WAN CE node 210b) through an SRv6 network (e.g., SRv6 network 120).

At block 720, LAN-side traffic (e.g., inbound LAN-side traffic 211a), originated by a first LAN (e.g., LAN 101a) coupled to the source SD-WAN CE node and destined for a second LAN (e.g., LAN 101b) coupled to the destination SD-WAN CE node, is received by the source SD-WAN CE node.

At block 730, the source SD-WAN CE node forwards the LAN-side traffic via the SRv6 tunnel, for example, in the form of encapsulated LAN-side traffic (e.g., in the form of IPv6 packets) to the destination CE node via the SRv6 tunnel. As described above, the encapsulated LAN-side traffic may include an outer IP packet having up to two IPv6 header levels, including (i) a first (top) header level, which as an IPv6 basic header and an IPv6 extension header (e.g., an IPv6 SRH) containing path information imposed by the SD-WAN CE node; and (ii) a second header level, which has an IPv6 basic header. As noted above, when the LAN-side traffic at issue is intended to traverse the SRv6 network via an SRv6 TE path (e.g., a low latency path or a bandwidth-assured path), the LAN-side traffic is encapsulated with both IPv6 header levels; however, when the LAN-side traffic at issue is intended to traverse the SRv6 network via an SRv6 BE path, the LAN-side traffic is encapsulated with only one IPv6 header level (i.e., the second header level) and no path information is imposed by the SD-WAN CE node. Depending on the particular implementation, the SD-WAN CE node may have used any of a number of different approaches to perform path information obtainment (e.g., Method 1, Method 2, or Method 3). The SD-WAN CE node may make use of the obtained path information, LAN-side traffic-profiles, and the current forwarding-plane state (e.g., forwarding-plane state 1110) of the SD-WAN CE node in connection with setting the SID-List of the IPv6 extension header as described herein.

While in the context of the flow diagram of FIG. 7 a number of enumerated blocks are included, it is to be understood that examples may include additional blocks before, after, and/or in between the enumerated blocks. Similarly, in some examples, one or more of the enumerated blocks may be omitted and/or performed in a different order.

Underlay Forwarding, Method 2 (RESTful API Call from Element/Policy Management System (E/PMS) Managing SD-WAN CE Nodes to SRv6 PCE)

Method 2 for path obtainment from SRv6 PCE differs from Method 1 in that it leverages an E/PMS managing the SD-WAN CE nodes for performing the REST API queries with the SRv6 PCE on behalf of the SD-WAN CE nodes. Method 2 can be beneficial in the scenario of an environment with many SD-WAN CE nodes and therefore using Method 1 could result in an overload issue on the SRv6 PCE due to a large number of RESTful API queries. In Method 2, the E/PMS managing SD-WAN CE nodes can aggregate all path requirements in a bulk API call to the SRv6 PCE, and therefore reduce API call volume.

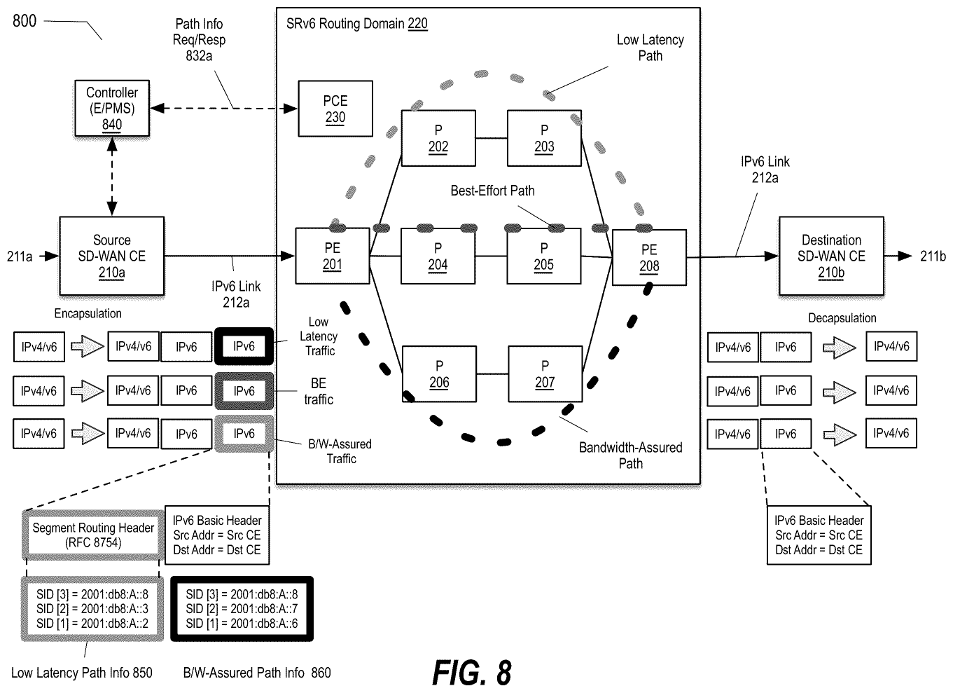

FIG. 8 is a block diagram illustrating an architecture 800 and approach for obtaining path information by a source SD-WAN CE node 210a indirectly from a PCE 230 via a controller 840, imposition of IPv6 SRH headers, and forwarding of LAN-side traffic through an SRv6 network via an SRv6 tunnel in accordance with a second embodiment of the present disclosure. In the context of the current example, the reference topology for the SRv6 routing domain 220 remains the same, but the source SD-WAN CE node 210a is now shown interacting with a controller 840 operating in the role of an E/PMS in connection with path information obtainment in accordance with Method 2.

In one embodiment, the controller 840 may represent a network security appliance management device (e.g., one of the FORTIMANAGER family of management appliances) with the management device taking the E/PMS role, and communicating with one or more SD-WAN CE nodes (e.g., source SD-WAN CE node 210a and potentially others (not shown)) via a management protocol (e.g., the FORTGATE to FORTIMANAGER (FGFM) protocol) for the implementation of path instruction. The path information may be pushed to source SD-WAN CE 210a from the controller on a periodic basis or pulled by source SD-WAN CE 210a from the controller 840 on a periodic basis via the management protocol or via an API exposed for this purpose by the device at issue.

According to one embodiment, in Method 2, the controller 840 issues a Path-Request (e.g., a REST API Path-Request call) to the PCE 230, asking for all SRv6 Traffic-Engineering (TE) policies required or designed by the SRv6 network administrator between source and destination SD-WAN CE nodes 210a and 210b. The controller 840 may then update the SD-WAN CE nodes configured with SRv6 tunnels with the path information obtained from the PCE 230.

The syntax for API Path-Request/response between E/PMS managing SD-WAN CE nodes and SRv6 PCE in Method 2 is fundamentally similar to that described above in connection with Method 1 with the difference being the entity that issues the request (i.e., controller 840 versus the SD-WAN source CE node 210a).

For the controller 840 to make an API call to the PCE, it should have the following information on each SD-WAN CE node: the Endpoint SID values of the PE node(s) that the local SD-WAN CE node directly connects with, the Endpoint SID values of the remote PE node(s) connected with the remote SD-WAN CE nodes, and the LAN-side traffic-profiles represented by colors. As mentioned above, the SRv6 network administrator is expected to pre-configure these values on each SD-WAN CE node, which may then report this information to the controller 840, for example, via the management protocol or via an API exposed by the controller 840 for such purposes. The suggested configuration for the reference topology used in the various examples described herein is shown and described with reference to FIG. 3. As in Method 1 (discussed above), the controller 840 in Method 2 should implement a retry mechanism to re-attempt the Path-Requests (e.g., REST API Path-Requests) in the event there is no response (e.g., RESTful API Path-Response) from the PCE 230 due to various reasons. The controller 840 should also maintain a reliable communication channel with the SD-WAN CE nodes.

After the controller 840 receives path information from the PCE 230, it may then update the SD-WAN CE nodes with the path information obtained from the PCE 230, for example, via the management protocol or via an API exposed by the SD-WAN CE nodes for such purposes.

### Underlay Forwarding, Method 3 (Static Path Configuration on SD-WAN CE Nodes)

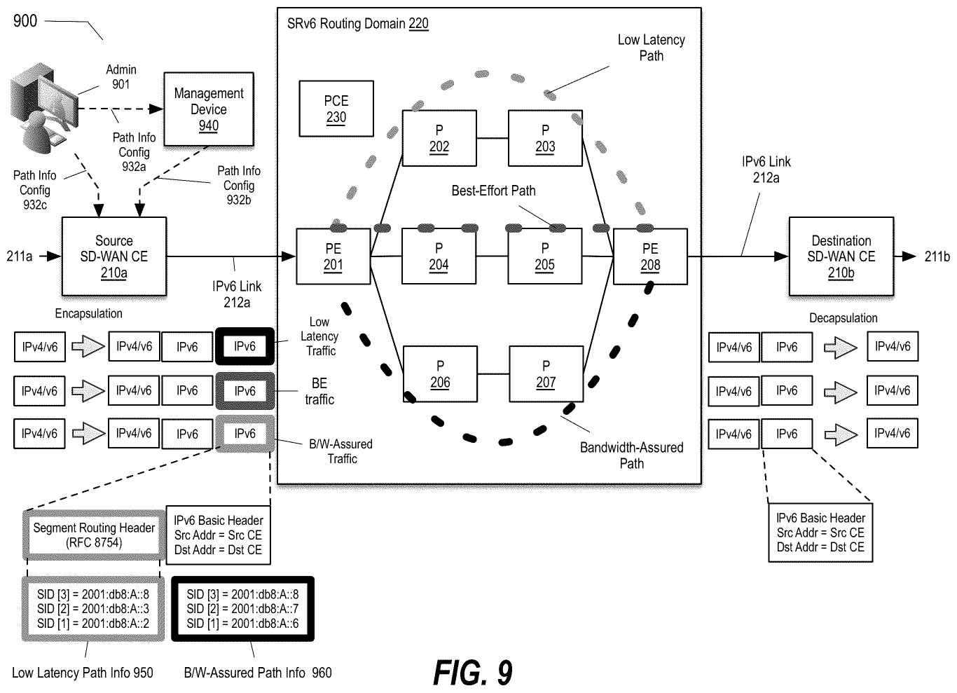

FIG. 9 is a block diagram illustrating an architecture 900 and approach for obtaining static path configuration by a source SD-WAN CE node 210a directly (e.g., path information configuration 932c) from an administrator 901 or indirectly (e.g., path information configuration 932a-b) via a CE management device 940, imposition of IPv6 SRH headers, and forwarding of LAN-side traffic through an SRv6 network via an SRv6 tunnel in accordance with a third embodiment of the present disclosure. In the context of the current example, the reference topology for the SRv6 routing domain 220 again remains the same; however, the administrator 901 (e.g., an SRv6 network administrator) statically configures the path information for traffic-engineered paths for the SRv6 tunnel on the source SD-WAN CE node 210a. The configuration can be done directly via a CLI or a web UI of the source SD-WAN CE or indirectly via a CLI or a web UI of the management device 940. In one embodiment, the management device 940 may represent a network security appliance management device (e.g., one of the FORTIMANAGER family of management appliances) with the management device communicating with the source SD-WAN CE node 210a and potentially others (not shown) via a management protocol (e.g., the FORTGATE to FORTIMANAGER (FGFM) protocol) for the implementation of path instruction. In the indirect static path configuration approach, the path information may be pushed to source SD-WAN CE 210a from the management device 940 or pulled by source SD-WAN CE 210a from the management device 940 via the management protocol or via an API exposed for this purpose by the device at issue.

### Example CLI Command Syntax for Static Path Configuration

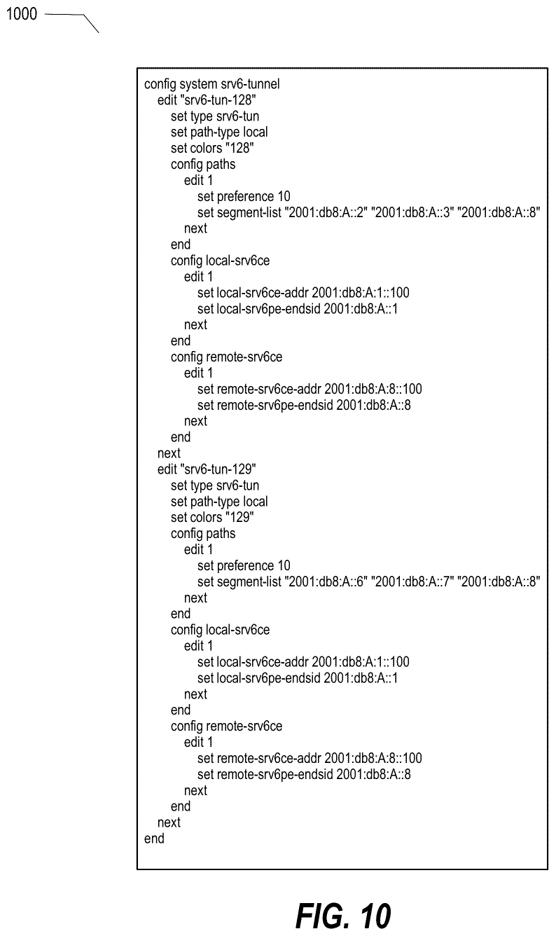

FIG. 10 is an example of a snippet 1000 of a CLI command syntax for static configuration of paths of an SRv6 tunnel on an SD-WAN CE node (e.g., source SD-WAN CE node 210a) in accordance with an embodiment of the present disclosure. The non-limiting example CLI configuration snippet 1000 shown in FIG. 10 includes new command syntaxes that may be used on SD-WAN CE nodes for the purpose of performing static path configuration. As will be appreciated by those skilled in the art, the actual command syntax may vary based on the vendor of the SD-WAN CE node at issue.

In the context of the present example, snippet 1000 assumes the static configuration of two paths: one path for the low-latency traffic-profile and the other path for the best-effort traffic-profile. In Method 3, because the SRv6 Segment-List is statically configured, the inherent SRv6 tunnel is fixed to a pair of specific source and destination End SID values of PE nodes.

### Underlay Forwarding, SRv6 Path Information Maintenance

Since the SRv6 TE paths are stateless from the perspective of SD-WAN CE nodes and the network conditions can change in a dynamic manner, the path instructions that SD-WAN CE nodes receive from the SRv6 PCE (e.g., PCE 230, as in Methods 1 or 2) may not always reflect the latest or best form of it. Therefore, in Method 1, SD-WAN CE node (e.g., source SD-WAN CD node 210a) and in Method 2, the E/PMS (e.g., controller 840) should implement techniques to verify path reachability and performance.

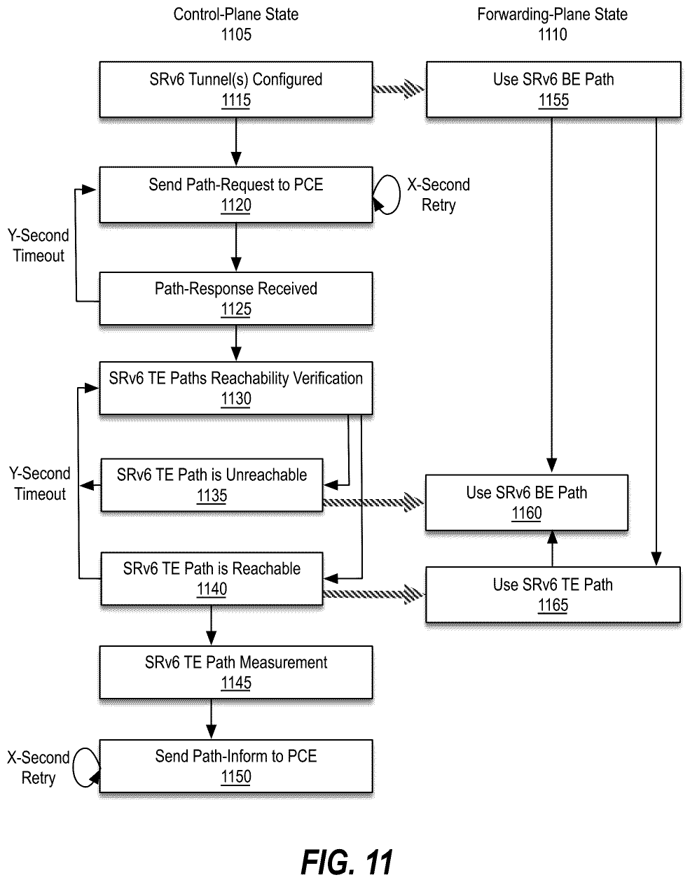

FIG. 11 is a block diagram conceptually illustrating techniques that may be used by control-plane and forwarding-plane state diagrams for SRv6 path information maintenance in accordance with an embodiment of the present disclosure. In the context of Method 1, all processing described with reference to control-plane state 1105 and forwarding-plane state 1110 may be performed by the source SD-WAN CD node (e.g., source SD-WAN CD node 210). In the context of Method 2, the path reachability related processing (e.g., associated with states 1130, 1135, and 1140) and the path performance measurement related processing (e.g., associated with states 1145 and 1150) should be performed by the E/PMS (e.g., controller 840) and all other processing described with reference to the other control-pane and forwarding-plane states should be performed by the source SD-WAN CD node.

At the start, in state 1115, once the source SD-WAN CE node is configured with the SRv6 tunnel(s) (e.g., SRv6 tunnel 125), the source SD-WAN CE node instantiates an SRv6 BE path (state 1155) for each pair of local and remote PE nodes (e.g., PE nodes 201 and 208) in the configuration, in order to provide basic connectivity between the source and destination SD-WAN CE nodes.

Next, in state 1120, the source SD-WAN CE node issues a Path-Request (e.g., a RESTful API Path-Request call) to the SRv6 PCE (e.g., PCE 230) with a continuous retry in a predetermined or configurable amount of time (e.g., X seconds) until successful. The parameters of the SRv6 PCE, such as target address, Hypertext Transfer Protocol (HTTP)/2 operating port, API syntax should be pre-configured on the source SD-WAN CE node.

In state 1125, the source SD-WAN CE starts a configurable timeout timer in a predetermined or configurable amount of time (e.g., Y seconds) to revert to state 1120. This is to ensure the received path information is still the latest intent of the SRv6 PCE. At this stage, the SRv6 BE Path is still used in the forwarding-plane. When such a timeout timer ends, the source SD-WAN CE node will issue a new Path-Request to the SRv6 PCE to inquire again about all paths between the associated local and remote PE nodes. Upon receiving the new paths, source SD-WAN CE node will assess and make decisions accordingly:
If there are new/additional paths, the source SD-WAN CE node performs a path reachability verification procedure for each of them.
If some paths have been removed, the source SD-WAN CE node will remove them from the path reachability verification procedure accordingly. Traffic previously carried on these removed paths is then switched onto SRv6 BE path by default.
If no path is included (e.g., an empty RESTful API Path-Response), the source SD-WAN CE node will apply the SRv6 BE path to all traffic streams between the associated local and remote PE nodes. Note that this is a different scenario from no RESTful API Path-Response from the SRv6 PCE as the latter is handled by a retry mechanism on the source SD-WAN CE node as discussed above with reference to Methods 1 and 2.

After a Path-Response (e.g., a RESTful API Path-Response), for example, for the first request, retrying request, or timing-out request) is received from the SRv6 PCE, the source SD-WAN CE node's control-plane state 1105 will transition into a path reachability verification stage (state 1135), which is described further below.

If the verification result is unreachable (state 1135), the SRv6 BE Path is maintained in the forwarding-plane (state 1160) and the source SD-WAN CE node will re-attempt after a predetermined or configurable timeout timer (e.g., Y seconds).

If the verification result is reachable (state 1140), the source SD-WAN CE node will switch over to the SRv6 TE path in the forwarding-plane (state 1165), and it will re-verify after the predetermined or configurable timeout timer (e.g., Y seconds).

In state 1145, The SD-WAN CE node will also start collecting performance metrics of the path, including, but not limited to throughput, latency, loss, jitter and then optionally issue feedback to the SRv6 PCE by issuing a Path-Inform call (e.g., a RESTful API Path-Inform call). It is up to the SRv6 PCE to use this information and/or make adjustment to path information, as these issues are outside the scope of this disclosure.

In the next verification attempt, if the result becomes unreachable the SD-WAN will switch back to the SRv6 BE Path in the forwarding-plane (state 1160), and stop the respective path measurement, and it will re-verify after a predetermined configurable timeout timer (e.g., Y seconds).

### Underlay Forwarding, SRv6 Path Reachability Verification

Since the SRv6 TE paths (e.g., the low latency path and the bandwidth-assured path) are stateless from the perspective of SD-WAN CE nodes, their reachability should be verified in an end-to-end manner to ensure the intent in the path instruction of the SRv6 PCE (e.g., PCE 230) resulted in a reachable path, avoiding traffic-blackholing.

According to one embodiment, SD-WAN CE nodes (e.g., source SD-WAN CE node 210a and destination SD-WAN CE node 210b) will auto-generate synthetic traffic across SRv6 TE paths and measure performance metrics of each SRv6 path such as throughput, latency, loss, jitter. The synthetic traffic may be encapsulated inside the SRv6 tunnels with an SRv6 SRH header (or substantial equivalent) containing the Segment-List that the SD-WAN CE nodes received from SRv6 PCE. As mentioned earlier, while it is possible for the path(s) sourced from the destination SD-WAN CE node 210b to be different from the ones sourced from the source SD-WAN CE node 210a, it is recommended that forward and reverse paths are symmetric in order to ensure consistent behavior for two-way traffic streams.

The synthetic traffic characteristics, such as protocols (e.g., Transmission Control protocol (TCP), User Datagram Protocol (UDP), Internet Control Message Protocol (ICMP)), port numbers, DSCP/IP precedence markings may be configurable on the SD-WAN CE nodes, which can include pre-built templates for typical traffic profiles accordingly (e.g., low-latency, bandwidth-assured, best-effort). The success criteria such as tolerance of loss, latency, jitter may also be configurable. The payload of the synthetic traffic should have metadata embedded to allow for mapping of synthetic traffic to the SRv6 TE path that it is intended to use.

According to one embodiment, for the SRv6 TE paths that are obtained from the SRv6 PCE (using Methods 1 and 2), their end-to-end reachability and performance will be measured to avoid traffic blackholing and then reported back to the SRv6 PCE to ensure the SRv6 PCE is aware of the actual forwarding conditions of the SRv6 TE paths that it instructed the SD-WAN CE nodes. It is up to the SRv6 PCE to use this information and/or adjust path information, as these are outside the scope of the present disclosure.

For the SRv6 TE paths that are statically configured (using method 3), both end-to-end reachability and performance may be measured to avoid traffic blackholing. In this example, the SD-WAN CE nodes are not required to report the performance metrics to the SRv6 PCE.

### Example Path-Inform Data

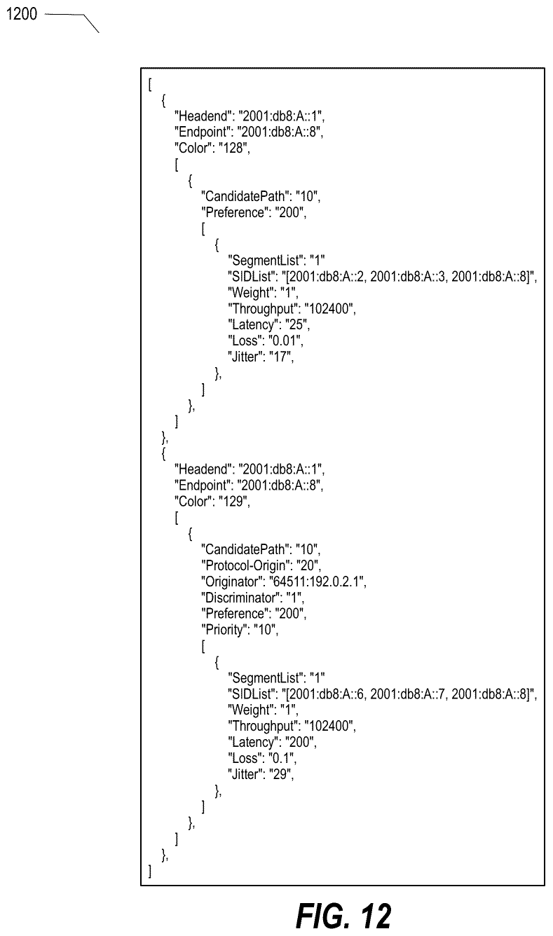

FIG. 12 is an example of Path-Inform data 1200 issued by a source SD-WAN CE node (e.g., source SD-WAN CE node 210a) to the SRv6 PCE (e.g., PCE 230) in accordance with an embodiment of the present disclosure. In the context of the present example, the Path-Inform data 1200 is presented in the form of a JSON expression. Those skilled in the art will appreciate other representations may be used. In this example, the Path-Inform data 1200 is an example of RESTful API Path-Inform data that may be issued by the source SD-WAN CE node, reporting to the SRv6 PCE the performance metrics (e.g., throughput, latency, loss, jitter) of the SRv6 TE paths obtained from the SRv6 PCE.

### Overlay Routing

Upon receiving the LAN-side traffic (IPv4/IPv6), the source SD-WAN CE node (e.g., source SD-WAN CE node 210a) should determine the destination SD-WAN CE node (e.g., destination SD-WAN CE node 210b) by using overlay routing methods so that the LAN-side traffic can be forwarded to the correct SRv6 tunnel. This disclosure does not suggest any new method for the overlay routing, but instead articulates how overlay routing methods can be arranged across an SRv6 tunnel (e.g., SRv6 tunnel 125).

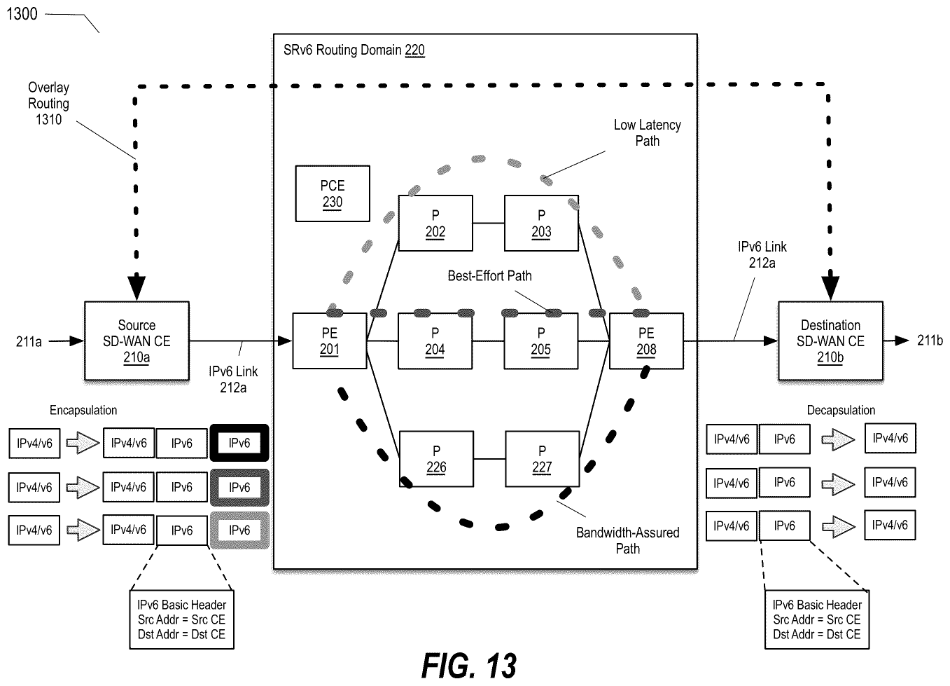

FIG. 13 is a block diagram illustrating overlay routing 1310 for an SRv6 tunnel (e.g., SRv6 tunnel 125) between SD-WAN CE nodes (e.g., source SD-WAN CE node 210a and destination SD-WAN CE node 210b) in accordance with an embodiment of the present disclosure. The SD-WAN CE nodes can use either static routing or dynamic routing to route LAN-side traffic across the SRv6 tunnel between each other. The SRv6 network (e.g., SRv6 network 120) is unaware of the overlay routing 1310.

With static routing, the source and destination SD-WAN CE nodes 210a and 210b may simply be configured or installed with static route(s) for the inner IPv4/IPv6 prefixes behind the SD-WAN CE nodes. These static routes have a next-hop address that is the IPv6 address of the Destination SD-WAN CE (which, in the context of the examples used herein is “2001:db8:A:8::100”) and an outgoing interface name that signifies the SRv6 tunnel (which in the context of the examples used herein is “srv6-tun”).

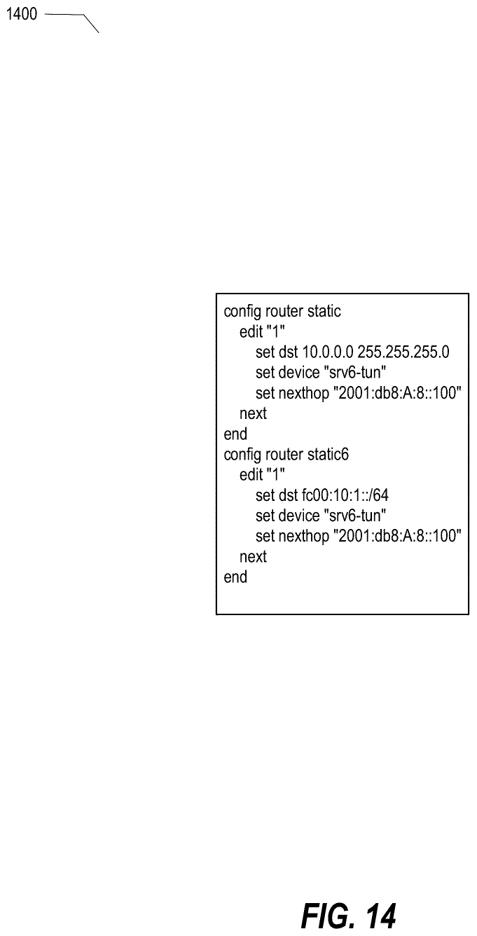

FIG. 14 is an example of a snippet 1400 of a CLI command syntax for configuring static overlay routing on an SD-WAN CE node (e.g., source SD-WAN CE node 210a and/or destination SD-WAN CE node 210b) in accordance with an embodiment of the present disclosure. With dynamic routing, the source and destination SD-WAN CE nodes 210a and 210b establish a routing relationship between each other using a dynamic routing protocol. The most suitable protocol that is used often in SD-WAN setting is BGP that can advertise not only IPv4/IPv6 prefixes (for TCP/IP Layer 3 routing) but also MAC/IP association (for TCP/IP Layer 2 switching). A typical example is the use of MP-BGP for EVPN-VXLAN (RFCs 7432, 8365).

If an SD-WAN CE node is single-homed to only one PE node (e.g., PE node 208 or 210), then it can use its IPv6 address on the PE-CE interface as source for its MP-BGP peering sessions with other SD-WAN CE nodes. The IPv4/IPv6 prefixes (for TCP/IP Layer 3 routing) and/or MAC/IP association (for TCP/IP Layer 2 switching) will be resolved on SD-WAN CE nodes with next-hop address being their IPv6 addresses on the respective PE-CE interface.

If an SD-WAN CE is multi-homed to several PE nodes, then it can use its IPv6 address on a loopback interface rather than the PE-CE interface as source for its MP-BGP peering sessions with other SD-WAN CE nodes. This is because otherwise, the number of MP-BGP peering sessions required will increase substantially. The IPv4/IPv6 prefixes (for TCP/IP Layer 3 routing) and/or MAC/IP association (for TCP/IP Layer 2 switching) will be resolved on SD-WAN CE nodes with next-hop address being their IPv6 addresses on the respective loopback interfaces.

### Overlay Routing for Multi-Homed SD-WAN CE Nodes

FIG. 15 is a block diagram illustrating overlay routing 1520 for an SRv6 tunnel (e.g., SRv6 tunnel 125) between multi-homed SD-WAN CE nodes (e.g., source SD-WAN CE node 1510a and destination SD-WAN CE node 1510b) in accordance with an embodiment of the present disclosure. In this example, a SRv6 routing domain 1520 is shown including a number of PE/P nodes, including PE nodes 1501, 1508, 1509 and 1510, and P nodes 1502-1507. Consider an SD-WAN network of 10 sites, where each site is dual-homed to two PE nodes, without a loopback interface as a BGP peering source, 380 BGP peering sessions in total will be required in a full-mesh manner. However, with BGP on loopback, only 90 BGP peering sessions in total will be required in a full-mesh manner. To support BGP on loopback, the PE nodes (e.g., PE nodes 1501, 1508, 1509, and 1510) should install a static route for the IPv6 address on a loopback interface of the associated SD-WAN CE node and redistribute the static route into the SRv6 routing domain 1520.

### Example Computer System

Embodiments of the present disclosure include various steps, which have been described above. The steps may be performed by hardware components or may be embodied in machine-executable instructions, which may be used to cause one or more processing resources (e.g., one or more general-purpose and/or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers, physical and/or virtual network security appliances) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

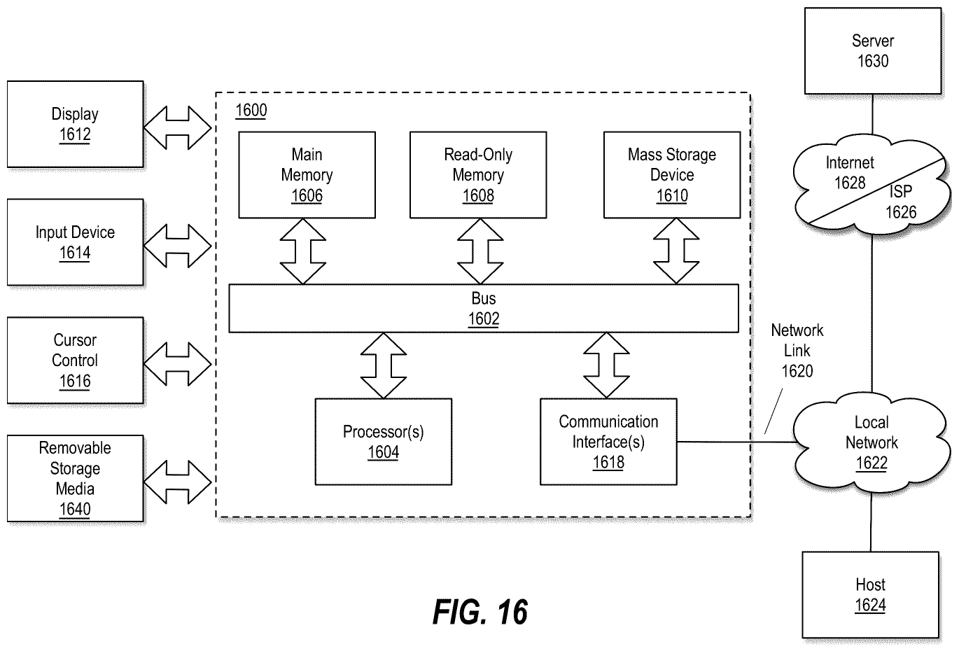

FIG. 16 is a block diagram that illustrates a computer system 1600 in which or with which an embodiment of the present disclosure may be implemented. Computer system 1600 may be representative of a network device, for example, an SD-WAN CE node (e.g., source SD-WAN CE node 210a), a controller (e.g., controller 840), or a management device (e.g., management device 940) involved in one or more aspects of Methods 1-3, described above, such as overlay routing, path obtainment, traffic steering, control-plane state maintenance, control-plane state processing, forwarding-plane state maintenance, forwarding-plane state processing, path reachability verification, and the like. Notably, components of computer system 1600 described herein are meant only to exemplify various possibilities. In no way should example computer system 1600 limit the scope of the present disclosure. In the context of the present example, computer system 1600 includes a bus 1602 or other communication mechanism for communicating information, and one or more processing resources (e.g., one or more hardware processors 1604) coupled with bus 1602 for processing information. Hardware processors 1604 may include, for example, one or more general purpose microprocessors available from one or more current or future microprocessor manufactures (e.g., Intel Corporation, Advanced Micro Devices, Inc., and/or the like) and/or one or more special purpose processors (e.g., CPs, NPs, and/or accelerators or co-processors). In some examples, the one or more processing resources may be part of an ASIC-based security processing unit (e.g., the FORTISP family of security processing units available from Fortinet, Inc. of Sunnyvale, CA).

Computer system 1600 also includes a main memory 1606, such as a random access memory (RAM) or other dynamic storage device, coupled to bus 1602 for storing information and instructions to be executed by processor(s) 1604. Main memory 1606 also may be used for storing temporary variables or other intermediate information during execution of instructions to be executed by processor(s) 1604. Such instructions, when stored in non-transitory storage media accessible to processor(s) 1604, render computer system 1600 into a special-purpose machine that is customized to perform the operations specified in the instructions.

Computer system 1600 further includes a read only memory (ROM) 1608 or other static storage device coupled to bus 1602 for storing static information and instructions for processor(s) 1604. A storage device 1610, e.g., a magnetic disk, optical disk or flash disk (made of flash memory chips), is provided and coupled to bus 1602 for storing information and instructions.

Computer system 1600 may be coupled via bus 1602 to a display 1612, e.g., a cathode ray tube (CRT), Liquid Crystal Display (LCD), Organic Light-Emitting Diode Display (OLED), Digital Light Processing Display (DLP) or the like, for displaying information to a computer user. An input device 1614, including alphanumeric and other keys, is coupled to bus 1602 for communicating information and command selections to processor(s) 1604. Another type of user input device is cursor control 1616, such as a mouse, a trackball, a trackpad, or cursor direction keys for communicating direction information and command selections to processor(s) 1604 and for controlling cursor movement on display 1612. This input device typically has two degrees of freedom in two axes, a first axis (e.g., x) and a second axis (e.g., y), that allows the device to specify positions in a plane.

Removable storage media 1640 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 1600 may implement the techniques described herein using customized hard-wired logic, one or more ASICs or FPGAs, firmware or program logic which in combination with the computer system causes or programs computer system 1600 to be a special-purpose machine. According to one embodiment, the techniques herein are performed by computer system 1600 in response to processor(s) 1604 executing one or more sequences of one or more instructions contained in main memory 1606. Such instructions may be read into main memory 1606 from another storage medium, such as storage device 1610. Execution of the sequences of instructions contained in main memory 1606 causes processor(s) 1604 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 1610. Volatile media includes dynamic memory, such as main memory 1606. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1602. Transmission media can also take the form of acoustic or light waves, such as those generated during radio-wave and infra-red data communications.

Various forms of media may be involved in carrying one or more sequences of one or more instructions to processor(s) 1604 for execution. For example, the instructions may initially be carried on a magnetic disk or solid state drive of a remote computer. The remote computer can load the instructions into its dynamic memory and send the instructions over a telephone line using a modem. A modem local to computer system 1600 can receive the data on the telephone line and use an infra-red transmitter to convert the data to an infra-red signal. An infra-red detector can receive the data carried in the infra-red signal and appropriate circuitry can place the data on bus 1602. Bus 1602 carries the data to main memory 1606, from which processor(s) 1604 retrieve and execute the instructions. The instructions received by main memory 1606 may optionally be stored on storage device 1610 either before or after execution by processor(s) 1604.

Computer system 1600 also includes a communication interface 1618 coupled to bus 1602. Communication interface 1618 provides a two-way data communication coupling to a network link 1620 that is connected to a local network 1622. For example, communication interface 1618 may be an integrated services digital network (ISDN) card, cable modem, satellite modem, or a modem to provide a data communication connection to a corresponding type of telephone line. As another example, communication interface 1618 may be a local area network (LAN) card to provide a data communication connection to a compatible LAN. Wireless links may also be implemented. In any such implementation, communication interface 1618 sends and receives electrical, electromagnetic or optical signals that carry digital data streams representing various types of information.

Network link 1620 typically provides data communication through one or more networks to other data devices. For example, network link 1620 may provide a connection through local network 1622 to a host computer 1624 or to data equipment operated by an Internet Service Provider (ISP) 1626. ISP 1626 in turn provides data communication services through the world-wide packet data communication network now commonly referred to as the “Internet” 1628. Local network 1622 and Internet 1628 both use electrical, electromagnetic or optical signals that carry digital data streams. The signals through the various networks and the signals on network link 1620 and through communication interface 1618, which carry the digital data to and from computer system 1600, are example forms of transmission media.

Computer system 1600 can send messages and receive data, including program code, through the network(s), network link 1620 and communication interface 1618. In the Internet example, a server 1630 might transmit a requested code for an application program through Internet 1628, ISP 1626, local network 1622 and communication interface 1618. The received code may be executed by processor(s) 1604 as it is received, or stored in storage device 1610, or other non-volatile storage for later execution.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for facilitating traffic steering within a segment routing (SR) over Internet Protocol (IP) version 6 (SRv6) network by a software-defined wide area networking (SD-WAN) customer equipment (CE) nodes without requiring the SD-WAN CE nodes to have SRv6 routing capabilities comprising:
establishing an end-to-end SRv6 tunnel through the SRv6 network between a source SD-WAN CE node associated with a first local area network (LAN) and a destination SD-WAN CE node associated with a second LAN;
receiving, by the source SD-WAN CE node, LAN-side traffic originated by the first LAN and destined for the second LAN;
based at least in part on the LAN-side traffic, encapsulating, by the source SD-WAN CE node, the LAN-side traffic as payload of an IP version 6 (IPv6) packet with one or more header levels, including incorporating path information within an IPv6 Extension Header (EH) of the IPv6 packet to instruct provider edge (PE) or provider (PE/P) nodes of the SRv6 network how to steer the IPv6 packet through the SRv6 network; and
transmitting, by the source SD-WAN CE node, the encapsulated LAN-side traffic to the destination SD-WAN CE node via the SRv6 tunnel.

2. The method of claim 1, further comprising obtaining, by the source SD-WAN CE node, the path information from a path computation engine of the SRv6 network.

3. The method of claim 1, further comprising obtaining the path information from a controller managing the source SD-WAN CE node.

4. The method of claim 1, further comprising obtaining the path information based on a static path configuration on the source SD-WAN CE node.

5. The method of claim 1, further comprising creating a mapping within the source SD-WAN CE node of a plurality of LAN-side traffic profiles to respective paths of the SRv6 tunnel.

6. The method of claim 1, further comprising handling and tracking state of SRv6 paths in a control-plane and a forwarding-plane of the source SD-WAN CE node.

7. A non-transitory machine readable medium storing instructions, which when executed by one or more processing resources of a software-defined wide area networking (SD-WAN) customer equipment (CE) node cause the SD-WAN CE node to:
establish an end-to-end segment routing (SR) over Internet Protocol (IP) version 6 (SRv6) tunnel through an SRv6 network with a destination SD-WAN CE node associated with a second local area network (LAN);
receive LAN-side traffic destined for the second LAN and originated by a first LAN with which the SD-WAN CE node is associated;
based at least in part on the LAN-side traffic, encapsulate the LAN-side traffic as payload of an IP version 6 (IPv6) packet with one or more header levels, including incorporating path information within an IPv6 Extension Header (EH) of the IPv6 packet to instruct provider edge (PE) or provider (PE/P) nodes of the SRv6 network how to steer the IPv6 packet through the SRv6 network; and
forward the encapsulated LAN-side traffic to the destination SD-WAN CE node via the SRv6 tunnel.

8. The non-transitory machine readable medium of claim 7, wherein the instructions further cause the SD-WAN CE node to obtain the path information from a path computation engine of the SRv6 network.

9. The non-transitory machine readable medium of claim 7, wherein the instructions further cause the SD-WAN CE node to obtain the path information from a controller managing the SD-WAN CE node.

10. The non-transitory machine readable medium of claim 7, wherein the instructions further cause the SD-WAN CE node to obtain the path information based on a static path configuration of the SD-WAN CE node.

11. The non-transitory machine readable medium of claim 7, wherein the instructions further cause the SD-WAN CE node to create a mapping between a plurality of LAN-side traffic profiles and respective paths of the SRv6 network.

12. The non-transitory machine readable medium of claim 11, wherein the plurality of LAN-side traffic profiles include one or more of LAN-side traffic matching a first set of one or more criteria for a low-latency path through the SRv6 network, LAN-side traffic matching a second set of one or more criteria for a bandwidth-assured path through the SRv6 network, and LAN-side traffic matching a third set of one or more criteria for a best effort path through the SRv6 network.

13. The non-transitory machine readable medium of claim 7, wherein the instructions further cause the SD-WAN CE node to handle and track state information regarding paths of the SRv6 network in a control-plane and a forwarding-plane of the source SD-WAN CE node.

14. A client equipment (CE) node comprising:
one or more processing resources; and
instructions that when executed by the one or more processing resources cause the CE node to:
establish an end-to-end segment routing (SR) over Internet Protocol (IP) version 6 (SRv6) tunnel through an SRv6 network with a destination CE node associated with a second local area network (LAN);
receive LAN-side traffic destined for the second LAN and originated by a first LAN with which the CE node is associated;
based at least in part on the LAN-side traffic, encapsulate the LAN-side traffic as payload of an IP version 6 (IPv6) packet with one or more header levels, including incorporating path information within an IPv6 Extension Header (EH) of the IPv6 packet to instruct provider edge (PE) or provider (PE/P) nodes of the SRv6 network how to steer the IPv6 packet through the SRv6 network; and
forward the encapsulated LAN-side traffic to the destination CE node via the SRv6 tunnel.

15. The CE node of claim 14, wherein the instructions further cause the CE node to obtain the path information from a path computation engine of the SRv6 network.

16. The CE node of claim 14, wherein the instructions further cause the CE node to obtain the path information from a controller managing the CE node.

17. The CE node of claim 14, wherein the instructions further cause the CE node to obtain the path information based on a static path configuration of the CE node.

18. The CE node of claim 14, wherein the instructions further cause the CE node to create a mapping between a plurality of LAN-side traffic profiles and respective paths of the SRv6 network.

19. The CE node of claim 18, wherein the plurality of LAN-side traffic profiles include one or more of LAN-side traffic matching a first set of one or more criteria for a low-latency path through the SRv6 network, LAN-side traffic matching a second set of one or more criteria for a bandwidth-assured path through the SRv6 network, and LAN-side traffic matching a third set of one or more criteria for a best effort path through the SRv6 network.

20. The CE node of claim 18, wherein the instructions further cause the CE node to handle and track state information regarding paths of the SRv6 network in a control-plane and a forwarding-plane of the CE node.
